(19) United States
(12) Patent Application Publication
(10) Pub. No.: US 2007/0105703 A1
(43) Pub. Date: May 10, 2007

(54) Deuteroxyle-doped silica glass, optical member and lithographic system comprising same and method of making same

(76) Inventors: Dana Craig Bookbinder, Corning, NY (US); Richard Michael Fiacco, Corning, NY (US)

Correspondence Address: CORNING INCORPORATED, SP-TI-3-1, CORNING, NY, 14831, US

(21) Appl. No.: 11/348,956

(22) Filed: Feb. 6, 2006

Related U.S. Application Data
(60) Provisional application No. 60/734,527, filed on Nov. 7, 2005.

(51) Int. Cl. C03B 8/00; C03B 19/06

(52) U.S. Cl. 501/54; 65/17.4; 65/17.2; 65/30.12

(57) ABSTRACT

What is disclosed includes OD-doped synthetic silica glass capable of being used in optical elements for use in lithography below about 300 nm. OD-doped synthetic silica glass was found to have significantly lower polarization-induced birefringence value than non-OD-doped silica glass with comparable concentration of OH. Also disclosed are processes for making OD-dopes synthetic silica glasses, optical member comprising such glasses, and lithographic systems comprising such optical member. The glass is particularly suitable for immersion lithographic systems due to the exceptionally low polarization-induced birefringence values at about 193 nm.

### FIELD OF THE INVENTION

The present invention relates to synthetic silica glass materials, optical elements and devices comprising the same and method of making the same. In particular, the present invention relates to synthetic silica glass material capable of being used in the optical elements in lithographic devices operating at a wavelength below about 300 nm, optical elements comprising the same, lithographic systems comprising such optical elements, process for making such glass material, and soot preform produced in such process. The present invention is useful, for example, in making synthetic fused silica glass materials for optical elements used in deep UV and vacuum UV lithographic devices, especially those involving immersion lithography in which linearly polarized UV light is employed.

### BACKGROUND OF THE INVENTION

As practiced commercially, fused silica optical members such as lenses, prisms, filters, photomasks, reflectors, etalon plates and windows, have been manufactured from bulk pieces of fused silica made in large production furnaces. Bulk pieces of fused silica manufactured in large production furnaces are known in the art as preforms, boules or ingots. Blanks are cut from boules or ingots, and finished optical members are manufactured from glass blanks, utilizing manufacturing steps that may include, but are not limited to, cutting, polishing, and/or coating pieces of glass from a blank. Many of these optical members are used in various apparatus employed in environments where they are exposed to ultraviolet light having a wavelength of about 360 nm or less, for example, an excimer laser beam or some other ultraviolet laser beam. The optical members are incorporated into a variety of instruments, including lithographic laser exposure equipment for producing highly integrated circuits, laser fabrication equipment, medical equipment, nuclear fusion equipment, or some other apparatus which uses a high-power ultraviolet laser beam.

As the photon energy, pulse energy and pulse rate of lasers increase, the optical members which are used in conjunction with such lasers are exposed to increased levels of energy. Fused silica has become widely used as the material of choice for optical members in such laser-based optical systems due to their excellent optical properties and resistance to light-induced damage.

Laser technology has advanced into the short wavelength, high energy ultraviolet spectral region, the effect of which is an increase in the frequency (decrease in wavelength) of light produced by lasers. Of particular interest are short wavelength lasers operating in the UV and deep UV (DUV) and vacuum UV wavelength ranges, which include, but are not limited to, lasers operating at about 248 nm, 193 nm, 157 nm and even shorter wavelengths. Excimer laser systems are popular in microlithography applications, and the shortened wavelengths allow for increased feature resolution and thus line densities in the manufacturing of integrated circuits and microchips, which enables the manufacture of circuits having decreased feature sizes. A direct physical consequence of shorter wavelengths (higher frequencies) is higher photon energies. In such optical systems, fused silica optics are exposed to high irradiation levels for prolonged periods of time, and this may result in the degradation of the optical properties of the optical members.

It is known that such light-induced degradation adversely affects the optical properties and performance of the fused silica optics by decreasing light transmission levels, discoloring the glass, altering the index of refraction, altering the density, and increasing absorption levels of the glass. Over the years, many methods have been suggested for improving the optical damage resistance of fused silica glass. It has been generally known that high purity fused silica prepared by such methods as flame hydrolysis, CVD-soot remelting process, plasma CVD process, electrical fusing of quartz crystal powder, and other methods, is susceptible to laser damage to various degrees.

A common suggestion has been to increase the OH content of such glass to a high level. For example, Escher, G. C., KrF Laser Induced Color Centers In Commercial Fused Silicas, SPIE Vol. 998, Excimer Beam Applications, pp. 30-37 (1988), confirms that defect generation rate is dependent upon the fused silica OH content, and that “wet” silica is the material of choice for KrF applications. Specifically, they note that high OH content silica is more damage resistant than low OH silica.

U.S. Pat. No. 5,086,352 and the related U.S. Pat. No. 5,325,230 has also disclosed that the ability to resist optical deterioration from exposure to a short wavelength ultraviolet laser beam depends on the OH group content in the presence of hydrogen. Specifically, these references show that for high purity silica glass having low OH content, KrF excimer laser durability is poor. Thus, they suggest an OH content of at least 50 ppm. Similarly, Yamagata, S., Improvement of Excimer Laser Durability of Silica Glass, Transactions of the Materials Research Society of Japan, Vol. 8, pp. 82-96 (1992), discloses the effect of dissolved hydrogen on fluorescence emission behavior and the degradation of transmission under irradiation of KrF excimer laser ray for high purity silica glass containing OH groups up to 750 ppm by weight such as those synthesized from high purity silicon tetrachloride by the oxygen flame hydrolysis method.

Others have also suggested methods of increasing the optical durability of fused silica. For example, Faile, S. P., and Roy, D. M., Mechanism of Color Center Destruction in Hydrogen Impregnated Radiation Resistant Glasses, Materials Research Bull., Vol. 5, pp. 385-390 (1970), have disclosed that hydrogen-impregnated glasses tend to resist gamma ray-induced radiation damage. Japanese Patent Abstract 40-10228 discloses a process by which a quartz glass article made by melting is heated at about 400 to 1000° C. in an atmosphere containing hydrogen to prevent colorization due to the influence of ionizing radiation (solarization). Similarly, Japanese Patent Abstract 39-23850 discloses that the transmittance of UV light by silica glass can be improved by heat treating the glass in a hydrogen atmosphere at 950 to 1400° C. followed by heat treatment in an oxygen atmosphere at the same temperature range.

Shelby, J. E., Radiation Effects in Hydrogen-impregnated Vitreous Silica, J. Applied Physics, Vol. 50, No. 5, pp. 3702-06 (1979), suggests that irradiation of hydrogen-impregnated vitreous silica suppresses the formation of optical defects, but that hydrogen impregnation also results in the formation of large quantities of bound hydroxyl and hydride, and also results in a change in density of the glass.

Recently, U.S. Pat. No. 5,410,428 has disclosed a method of preventing induced optical degradation by a complicated combination of treatment processes and compositional manipulations of the fused silica members to achieve a particular hydrogen concentration and refractive index, in order to improve resistance to UV laser light degradation. It is suggested that under such UV irradiation some chemical bonds between silicon and oxygen in the network structure of the fused silica is generally broken and then rejoins with other structures resulting in an increased local density and an increased local refractive index of the fused silica at the target area.

More recently, U.S. Pat. No. 5,616,159 to Araujo et al. disclosed a high purity fused silica having high resistance to optical damage up to 10⁷ pulses (350 mJ/cm²/pulse) at the laser wavelength of 248 nm and a method for making such glass. The composition disclosed in Araujo et al. comprises at least 50 ppm OH and has a concentration of H₂ greater than 1×10¹⁸ molecules/cm³.

It has been reported that when silica glass is exposed to non-polarized or circularly polarized UV laser beam, usually in the peripheral area of the exposure light beam, additional birefringence (induced edge birefringence) is generated due to strain caused by laser damage, but in the center area of the light beam, there is usually negligible induced birefringence. Recently, a new phenomenon of laser damage to silica material has been observed: when the silica glass is exposed to linearly polarized deep UV laser beam, in addition to the induced edge birefringence, additional birefringence is induced in the center of the exposed area of the glass (“polarization-induced birefringence” or “PIB”). The induced birefringence, especially polarization-induced birefringence, is of particular concern to immersion lithography systems where a liquid fills the gap between the last lens element and the wafer in order to enlarge the numerical aperture of the lens system. In such immersion lithography systems, the polarization state of the UV radiation needs to be controlled, desirably linearly polarized. The induced birefringence in the glass alters the polarization state of the UV radiation, causing reduction of phase contrast and system resolution. Therefore, for deep UV and vacuum UV immersion lithographic systems, it is highly desirable that the glass material used in making the lens elements has low induced birefringence damage, especially a low polarization-induced birefringence, when exposed to linearly or elliptically polarized UV radiation, in addition to low light-induced wave-front distortion (“LIWFD”) and high transmission.

C. K. Van Peski et al. reports in Journal of Non-Crystalline Solids 265, 285 (2000) the experimental observation of the polarization-induced birefringence effect within a SEMATECH study in which fused silica of several suppliers was exposed and measured. The publication does not disclose any details about the samples other than the measured damage. N. F. Borrelli et al., Applied Physics Letters 80 (2), 219 (2002) reports observation of the effect in different types of fused silica made via the so-called direct glass process. Here, polarization-induced birefringence was shown to occur in samples exhibiting retarded wavefront in the damaged area (then called compaction) as well as in samples exhibiting advanced wavefront in the damaged area (then called expansion). An explanation of polarization-induced birefringence in terms of anisotropic density change is introduced. European patent application publication EP1340722A1 mentions polarization-induced birefringence in silica glass. However, it is not clear whether the examples in this patent reference disclose polarization-induced birefringence for the several glasses of different compositions made by using the soot-to-glass process. It appears from the specification of this reference that the examples are concerned with birefringence induced by circularly polarized irradiation or by non-polarized irradiation.

Therefore, there exists a need for a synthetic silica material having, inter alia, a low level of polarization-induced birefringence, a low level of light-induced wavefront distortion, a high level of initial internal transmission, and method of making the same.

The present invention satisfies the above described needs for synthetic silica glass for use in lithographic applications.

### SUMMARY OF THE INVENTION

According to a first aspect of the present invention, it is provided an OD-doped synthetic silica glass material capable of being used in the light path of the lithographic irradiation of a lithographic device operating at a wavelength below about 300 nm comprising OD and optionally OH, wherein the ratio of n(OD)/(n(OD)+n(OH)) is higher than 2×10⁻⁴.

In one embodiment of the first aspect of the present invention, the glass comprises less than about 500 ppm by weight of OH and 0.15-1400 ppm OD.

In another embodiment of the first aspect of the present invention, the glass comprises less than about 150 ppm by weight of OH and about 0.1-1400 ppm OD.

In yet another embodiment of the first aspect of the present invention, the glass comprises less than about 20 ppm by weight of OH and about 0.01-1400 ppm OD.

In still another embodiment of the first aspect of the present invention, the glass comprises less than about 20 ppm by weight OH and between about 0.01-300 ppm OD.

In still another embodiment of the first aspect of the present invention, the glass comprises less than about 20 ppm by weight OH and between about 0.01-150 ppm OD.

In yet another embodiment of the first aspect of the present invention, the glass comprises less than about 1 ppm by weight OH and between about 0.01-150 ppm OD.

A second aspect of the present invention is an optical member capable of being used in the light path of the lithographic irradiation of a lithographic device operating at a wavelength below about 300 nm comprising the OD-doped synthetic silica glass of the present invention described summarily above and in detail below. In certain embodiments, the optical member is a refractive optical member where the irradiation travels through at least part of the body of the optical member. In certain other embodiments, the optical member is a reflective optical member where the irradiation is reflected upon at least part of the surface of the optical member.

A third aspect of the present invention is a lithographic system comprising the optical member of the present invention described summarily above and in detail below. In certain embodiments, the lithographic system is an immersion lithographic system. The lithographic system may operate at about 248 nm, 193 nm or even shorter.

A fourth aspect of the present invention is a process for making OD-doped synthetic silica glass material, comprising the following steps:

(I) providing a plurality of particles comprising silica;

(II) depositing the plurality of particles on a supportive deposition surface at an elevated temperature such that the particles are consolidated into transparent glass material in situ

wherein:

either in step (I), the plurality of particles provided are D-containing and/or in step (II), the deposition and consolidation are carried out in an D-containing atmosphere,

such that the obtained silica glass comprises OD and optionally OH, and the ratio of n(OD)/(n(OD)+n(OH)) is higher than about 2×10⁻⁴, in certain embodiments preferably higher than about 0.1, in certain other embodiments higher than about 0.3, in certain other embodiments higher than about 0.5, in certain other embodiments higher than 0.8, in yet still other embodiments higher than about 0.9.

A fifth aspect of the present application is a process for making OD-doped synthetic silica glass material, comprising the following steps:

(A) providing a particle preform comprising a plurality of particles comprising silica;

(B) optionally purifying and/or drying the particle preform;

(C) optionally further doping the particle preform with dopants;

(D) consolidating the particle preform at an elevated temperature to dense glass; and

(E) optionally treating the consolidated glass obtained in step (D) in the presence of H₂, HD and/or D₂,

wherein in at least one of steps (A), (B), (C), (D) and (E), OD is introduced or formed into the glass.

A sixth aspect of the present invention is a process for making OD-doped synthetic silica glass, comprising the following steps:

(a) providing a plurality of OD-doped particles comprising silica; and

(b) melting the particles at an elevated temperature to obtain a transparent glass.

A seventh aspect of the present invention is a particle preform formed during a process of the present invention generally described above and in detail below.

The OD-doped synthetic lithographic silica glass of the present invention has the advantage of higher optical performance at certain wavelength shorter than about 300 nm, such as at 193 nm, compared to conventional silica glass which is essentially non-OD-doped.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and is incorporated in and constitutes a part of this specification.

### BRIEF DESCRIPTION OF THE DRAWINGS

In the accompanying drawings,

FIG. 1 is schematic illustration of one proposed mechanism accounting at least partly for polarization-induced birefingence in silica glass comprising OH and/or OD moieties.

FIG. 2 is a schematic illustration of a proposed mechanism accounting at least partly for polarization-induced birefringence in silica glass comprising OH and/or OD moieties, and the difference in terms of level of polarization-induced birefringence between glasses having different n(OD)/(n(OD)+n(OH)) ratios.

FIG. 3 is a schematic illustration of a proposed mechanism accounting at least partly for the polarization-induced birefringence and light-induced wavefront distortion (LIWFD) in silica glass comprising OH and/or OD moieties, and the difference in terms of level of polarization-induced birefringence and LIWFD between glasses having different n(OD)/(n(OD)+n(OH)) ratios.

FIG. 4 is a diagram showing the OH concentration ([OH]) and OD concentration ([OD]) profiles of a consolidated silica glass sample produced according to one embodiment of the processes of the present invention for making OD-doped silica glass of the present invention.

FIG. 5 is a diagram showing the [OH] and [OD] profiles of a consolidated OD-doped silica glass prepared according to one embodiment of the process of the present invention for making OD-doped silica glass of the present invention.

FIG. 6 is a diagram showing polarization-induced birefringence, measured at 633 nm, of a series of OD-doped silica glass samples of the present invention, and a series of OH-doped silica glass samples, having various levels of molecular H₂ or D₂, as a function of N(P)·F, where F is fluence, and N(P) is number of pulses of a pulsed laser beam having a wavelength of about 193 nm, a fluence of about 200 μJcm·⁻²·pulse⁻¹ and a pulse length of approximately 25 ns and a repetition rate of about 4 kHz to which the glass samples were exposed.

FIG. 7 is a diagram showing normalized polarization-induced birefringence of the same samples of FIG. 6, as a function of number of pulses of a pulsed laser beam having a wavelength of about 193 nm, a fluence of about 200 μJ·cm⁻²·pulse⁻¹ and a pulse length of approximately 25 ns and a repetition rate of about 4 kHz to which the glass samples were exposed.

FIG. 8 is a diagram showing normalized LIWFD measured at 633 nm of the same series of OD-doped silica glass samples of the present invention, and the same series of OH-doped silica glass samples as presented in FIG. 6 above, as a function of number of pulses of a pulsed laser beam having a wavelength of about 193 nm, a fluence of about 200 μJ·cm⁻²·pulse⁻¹ and a pulse length of approximately 25 ns and a repetition rate of about 4 kHz to which the glass samples were exposed.

FIG. 9 is a diagram showing normalized LIWFD measured at 193 nm of the same series of OD-doped silica glass samples of the present invention, and the same series of OH-doped silica glass samples as presented in FIG. 6 above, as a function of number of pulses of a pulsed laser beam having a wavelength of about 193 nm, a fluence of about 200 μJ·cm⁻²·pulse⁻¹ and a pulse length of approximately 25 ns and a repetition rate of about 4 kHz to which the glass samples were exposed.

### DETAILED DESCRIPTION OF THE INVENTION

As used herein, the term “D-containing compound” means a chemical compound or an elemental substance comprising deuterium atom(s) (₁²D, “D”) and optionally pronium atom(s) (₁¹H, “H”), in which the ratio of n(D)/(n(D)+n(H)) is higher than the natural isotopic abundance of D, where n(D) is the total number of D atoms in the molecule of the D-containing compound, and n(H) is the total number of H atoms in the molecule of the D-containing compound. Examples of D-containing compound thus include, but are not limited to: D₂, DH, CD₄, CDH₃, D₂O, DHO, and the like. As used herein, the term “D-containing” means that an elemental substance, a compound, a material, or an atmosphere in which the ratio of n(D)/(n(D)+n(H)) is higher than the natural isotopic abundance of D.

As used herein, the term “hydroxyl(s)” or OH means a moiety or a group of moieties each consisting of an oxygen atom and a pronium atom (H). The oxygen atom may be ¹⁶O, ¹⁷O or ¹⁸O, or mixtures thereof at any proportion. As used herein, n(OH) means the total number of OH moieties in a material.

As used herein, the term “deuteroxyl(s)” or OD means a moiety or a group of moieties each consisting of an oxygen atom and a deuterium atom (D). The oxygen atom may be ¹⁶O, ¹⁷O or ¹⁸O, or mixtures thereof at any proportion. As used herein, n(OD) means the total number of OD moieties in a material.

In the present application, the two terms “hydroxyl-doped” and “OH-doped” are used interchangeably. A hydroxyl-doped or OH-doped material means the material comprises OH moieties and optionally OD moieties, and the ratio of n(OH)/(n(OD)+n(OH)) in the material is equal to or higher than the natural isotopic abundance of H. To that extent, a material in which all the OH moieties originate from normal water comprising H₂O and D₂O at essentially the natural isotopic abundances of H and D is regarded as OH-doped.

In the present application, the two terms “deuteroxyl-doped” or “OD-doped” are used interchangeably. A deuteroxyl-doped or OD-doped material means the material comprises OD moieties and optionally OH moieties, and the ratio of n(OD)/(n(OD)+n(OH)) in the material is higher than the natural isotopic abundance of D.

By “F-doped” in the present application, it is meant that the glass comprises at least 1 ppm by weight of fluorine.

As used herein, the term “polarization-induced birefringence” means the peak measured birefringence level in the center portion of the uniformly exposed area of the glass after a certain time interval or laser pulses, if a pulsed laser beam is used, less the initial birefringence of the glass before the exposure. The polarization-induced birefringence levels as claimed in the present application are magnitude (absolute value) thereof. In the present application, when exposing the glass to quantify the polarization-induced birefringence level of the silica glass, a linearly polarized pulsed laser beam at approximately 193 nm having about 3 mm diameter with a given fluence and pulse length is directed to a fixed area of the glass sample. The birefringence at the center portion of the exposed area is measured after a certain number of pulses. The polarization-induced birefringence value is calculated by subtracting the initial birefringence of the glass from the measured center birefringence.

As used herein, the term “induced edge birefringence” means the measured peak birefringence level in the peripheral portion outside of but abutting the exposed area (i.e., the area right at the aperture where the light intensity changes from nominal value to zero) of the glass after a certain time interval or laser pulses, if a pulsed laser beam is used, less the initial birefringence of the glass before the exposure. In the present application, the induced edge birefringence of the silica glass is measured after a linearly polarized pulsed laser beam at approximately 193 nm having about 3 mm diameter with a given fluence and pulse length has been directed to a fixed area of the glass sample for a certain period of time or a given number of pulses. The induced edge birefringence value is calculated by subtracting the initial birefringence of the glass from the peak measured birefringence at the peripheral portion.

As used herein, “low polarization-induced birefringence” means a polarization-induced birefringence of less than or equal to 0.1 nm/cm measured at about 633 nm after being subjected to 5×10⁹ pulses of linearly polarized pulsed laser beam at about 193 nm having a fluence of about 40 μJ·cm⁻²·pulse⁻¹ and a pulse length of about 25 ns.

As used herein, “normalized polarization-induced birefringence” is calculated from the measured polarization-induced birefringence as follows:

$$PIB ( N ) = \frac{PIB ( M )}{{N}_{1} \cdot F} \times 14 ,$$

where PIB(N) is normalized polarization-induced birefringence, PIB(M) is magnitude of measured polarization-induced birefringence in nm/cm measured at about 633 nm, N₁ is number of pulses in billion pulses, F is fluence of the ArF laser to which the glass is exposed to in mJ·cm⁻²·pulse⁻¹. For example, for a glass sample exposed to ArF laser with a fluence of 40 μJ·cm⁻²·pulse⁻¹ for 2×10¹⁰ pulses having a magnitude of resultant measured PIB(M) of 0.2 nm/cm, its PIB(N) is calculated as follows:

$$PIB ( N ) = \frac{PIB ( M )}{{N}_{1} \cdot F} \times 14 = \frac{0.2}{20 \times 0.04} \times 14 = 3.5 .$$

A single sample may have differing PIB(N) when measured at differing N₁ and F. PIB(N) reported or described in the present application are values thereof at specified N₁.

Light-induced wavefront distortion of the bulk glass (“bulk LIWFD”) is measured at 633 nm or 193 nm using method and apparatus available in the prior art. Normalized LIWFD of the glass subjected to pulsed ArF excimer laser (about 193 nm) measured at 633 nm (L633) and 193 nm (L193) are calculated in accordance with the following equations:

$$L 633 = \frac{LB 633}{0.95 \cdot {( {N}^{′} \cdot \frac{{F}^{2}}{τ} )}^{0.6}} \qquad and \qquad L 193 = \frac{LB 193}{1.67 \cdot {( {N}^{′} \cdot \frac{{F}^{2}}{τ} )}^{0.6}} ,$$

where LB633 is bulk LIWFD measured at 633 nm in nm/cm, LB193 is bulk LIWFD measured at 193 nm in nm/cm, N′ is number of pulse in million of the ArF excimer laser to which the sample was exposed to when the LB633 or LB193 is measured, F is the fluence of the ArF excimer laser in mJ·cm⁻²·pulse⁻¹, and τ is pulse length of the ArF excimer laser in ns. The L633 and L193 values enable direct comparison of LIWFD performance of the silica glasses at different N′, F and τ values.

As used herein, the term “variation of refractive index,” or “refractive index variation,” or “Δn,” means the maximal variation of refractive indices measured in a plane perpendicular to the optical axis of the glass material or glass optical member along a predetermined direction by using interferometry at about 633 nm (He—Ne laser) (with tilt and piston taken out, as indicated infra). As is typically done by one skilled in the art, when discussing refractive index variation along a certain direction, tilt and piston are subtracted. Therefore, the refractive index variation along a certain direction (such as the radial direction in a sample prepared by using the OVD process) in the meaning of the present application does not include tilt or piston. Typically, the optical axis of a glass optical member, a glass blank, or a piece of glass material, is selected to be perpendicular to a plane (a cross-section) in which the measured refractive index inhomogeneity is the smallest, in order to obtain a glass member having large clear aperture area.

The preferred method, also the method used herein, for determination of interstitial molecular H₂ in fused silica is Raman scattering. Raman spectrometry is obtained using a T64000 spectrometer from HORIBA Jobin Yvon Inc. with an EEV charge-coupled device (CCD) detector. The hydrogen molecule concentration in molecules/cm³ was obtained from the ratio of the intensity detected from the hydrogen molecule scattering peak at 4135 cm⁻¹ (I₄₁₃₅) to the intensity of the silica scattering peak at 800 cm⁻¹ (I₈₀₀), i.e., I₄₁₃₅/I₈₀₀, in the laser Raman spectrum (See, V. S. Khotimchenkô et al., Prikladnoi Spektroskopii, 46 (6), 987-997 (1986)). More specifically, the intensities of the peaks were determined by integrating the areas under the peaks using a linear or quadratic fit to the background. D₂ and HD concentrations in the glass in the present application were measured using Raman spectroscopy as well. D₂ concentration was measured at 2973 cm⁻¹ and HD concentration was measured at 3606 cm⁻¹.

The OH group has characteristic absorption bands near 2.72 μm (3676 cm⁻¹), 2.21 μm (4525 cm⁻¹) and 1.38 μm (7246 cm⁻¹) in fused silica. Concentration of OH was measured by FTIR using the peak height of either the 3676 cm⁻¹ or the 4525 cm⁻¹ absorption band.

The OH concentration, c, in mol·liter⁻¹, is derived from the Beers-Lambert Law
A=ε·c·b,
where the absorbance A=log(T_{ref}/T_{OH}); T_{ref}=Transmittance of sample at reference position, a non-absorbing wavelength such as 4000 cm⁻¹; T_{OH}=Transmittance of sample at OH absorption peak (˜3676 cm⁻¹ for silica); ε is the molar absorptivity in liter·mol⁻¹·cm⁻¹; c is concentration in mol·liter⁻¹; and b is the pathlength (sample thickness) in cm:
c(mol·liter⁻¹)=A/(ε·b).

Concentration of OH in ppm by weight was calculated from c in mol·liter⁻¹ using the density of the silica glass (approximately 2.2 g/cm³) and molecular weight of OH (approximately 17 g/mol). The constant ε for high purity silica glass at a particular wavelength is available in the prior art.

Concentration of OD in silica glass was obtained in a similar manner, namely, starting from FTIR measurement and calculated by using the Beers-Lambert Law. To calculate the concentration in parts per million we used the Beers-Lambert law:
A′=ε′·c′·b′,
where the absorbance A′=log(T′_{ref}/T_{OD}); T′_{ref}=Transmittance of sample at reference position, a non-absorbing wavelength such as 2780 cm⁻¹; T_{OD}=Transmittance of sample at OD absorption peak (˜2705 cm⁻¹ for silica); ε′ is the molar absorptivity in liter·mol⁻¹·cm⁻¹ (57.4 liter·mol⁻¹ ·cm⁻¹ at 2705 cm⁻¹); c′ is concentration of OD in mol·liter⁻¹; and b′ is the path length (sample thickness) in cm:
c′(mol·liter⁻¹)=A′/(ε′·b′).

Concentration of OD in ppm by weight was calculated from c′ in mol·liter⁻¹ using the density of the silica glass (approximately 2.2 g/cm³) and molecular weight of OD (approximately 18 g/mol). The constant ε′ for high purity silica glass at a particular wavelength is available in the prior art.

As used herein, a particle preform means an object having a shape and comprising a plurality of solid particles. Thus a particle preform in the present application may be, for example, a soot preform consisting essentially of silica soot particles obtained from flame hydrolysis processes, a green body comprising a number of silica particles obtained from the sol-gel process, and the like.

As used herein, the term soot gun means a device which sprays pre-formed soot particles at a predetermined temperature and/or velocity.

In search of silica glass materials with desired optical properties, especially in terms of initial internal transmission, LIWFD, light-induced absorption, polarization-induced birefringence, and the like, the present inventors have unexpectedly found that OD-doped high purity fused silica glass exhibits comparable, and in certain important respects, superior, performance than non-OD-doped glass with comparable OH concentration. The present invention is based on this discovery.

Silica glasses comprising D₂ (molecular deuterium) has been disclosed and studied in the prior art before. For example, U.S. Pat. No. 5,325,230(A) to Yamagata et al. mentions that D₂, as well as H₂, may be doped into fused silica glass. However, this reference does not provide an example of D₂ doped silica glass. Moreover, it does not mention doping silica glass with OD. Still, it does not mention the potential impact of doping silica glass with D₂ on the optical properties of the glass. For another example, J. E. Shelby, Molecular diffusion and solubility of hydrogen isotopes in vitreous silica, Journal of Applied Physics, Volume 48, No. 8 (August 1977), discloses the diffusion and solubility of D₂ in fused silica glass.

D. L. Fry et al., Hydrogen-Deuterium Exchange in Fused Silica, Journal of The Optical Society of America, Volume 50, No. 12 (December 1960), pages 1321-22, discusses OD-doped fused silica glass. No mention is made in this reference of the optical properties of the OD-doped fused silica glass in this article. Given the early publication date of this article, one of ordinary skill in the art can reasonably believe that the glass studied in this article did not have the required composition and optical properties for use in modern deep UV and vacuum UV lithography. James E. Shelby, Quantitative Determination of the Deuteroxyl Content of Vitreous Silica, Communication of the American Ceramic Society(January 1987), C-9 to C-10, discloses OD-doped fused silica glass and method for characterizing such glass. J. E. Shelby et al., Radiation-induced isotope exchange in vitreous silica, Journal of Applied Physics 50(8) (August 1979), pages 5533-35, studied the formation of OD in fused silica glass from the reaction of silica and D₂ when exposed to γ-radiation.

None of the above references mentions a synthetic silica glass material capable of being used in the light path of the lithographic irradiation of a lithographic device operating at a wavelength below about 300 nm. None of the references above discloses or suggests the desirability of doping synthetic silica glass with OD or D₂ for UV lithographic applications. In view of the early publication dates of most of the above-mentioned references, one of ordinary skill in the art has reason to believe that the actual D₂ or OD-doped fused silica glass samples studied in the above references do not have the composition and properties required for use in deep UV or vacuum UV lithographic applications, especially in terms of initial internal transmission, LIWFD, polarization-induced birefringence, induced absorption and the like, such as at about 248 nm or 193 nm.

The present inventors have prepared synthetic silica glass materials doped with OD capable of being used in below 300 nm UV lithographic applications. As mentioned above, the present inventors have found that, unexpectedly, OD-doped lithographic synthetic silica glass materials, especially those with a high n(OD)/(n(OD)+n(OH)) ratio, tend to have better optical properties than non-OD-doped silica glass with essentially the same level of total concentration of OH and OD ([OH]+[OD]).

Co-pending, co-assigned U.S. patent application Ser. No. 11/241,075, entitled “SYNTHETIC SILICA HAVING LOW POLARIZATION-INDUCED BIREFRINGENCE, METHOD OF MAKING SAME AND LITHOGRAPHIC DEVICE COMPRISING SAME” and filed on Sep. 30, 2005, discloses and studies the polarization-induced birefringence phenomenon in synthetic silica glass material, the content of which is incorporated herein by reference in its entirety. The silica glass materials studied in the examples of this patent application were essentially OH-doped. It states that “among others, OH concentration in the glass is a major factor affecting the polarization-induced birefringence of the glass. Generally, all other conditions remaining equal, the higher the OH level, the higher the polarization-induced birefringence of the glass. Thus, the present inventors have found that, to achieve a low level of polarization-induced birefringence in the silica glass, it is desired that the OH concentration in the glass is less than 500 ppm by weight, preferably less than 300 ppm, more preferably less than 100 ppm, still more preferably less than 50 ppm, most preferably less than 20 ppm.”

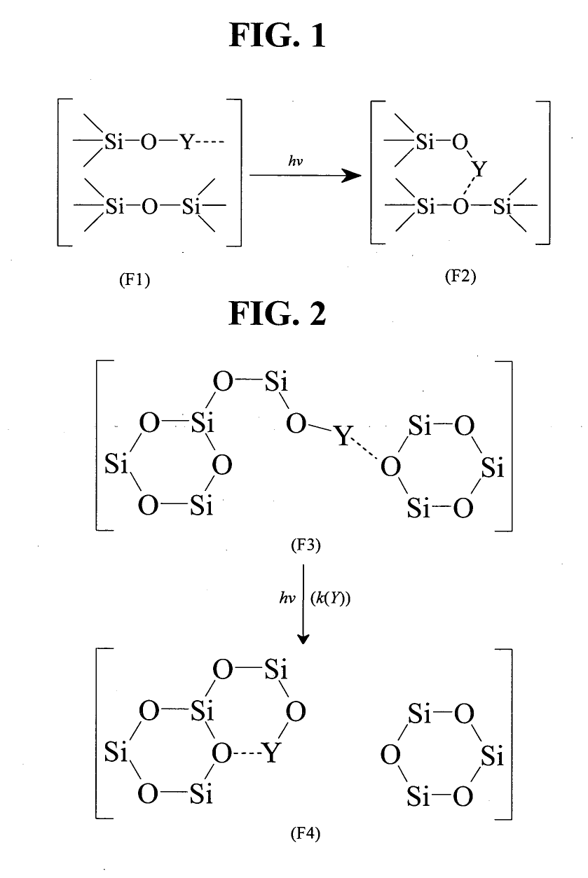

With no intention or necessity to be bound by any particular theory, the present inventors present the following explanation of the mechanism of polarization-induced birefringence in fused silica glass comprising OH and/or OD, as well as the mechanism accounting for the lower polarization-induced birefringence in fused silica glass having a higher n(OD)/(n(OD)+n(OH)) ratio. The explanation is schematically illustrated in FIGS. 1-3 of the present application. In these three figures, Y represents H or D, and hydrogen bonds are shown as dotted lines.

A 1999 paper titled “Hydroxyl Groups in High-Purity Silica Glass,” Journal of Non-Crystalline Solids, 261 (2000), pages 186-94, describes different types of OH bonding in SiO₂. The present inventors expect that OD are bonded in the network of SiO₂ glass structure in essentially the same ways. FIG. 1 schematically illustrates a proposed mechanism aiming to interpret at least part of the polarization-induced birefringence generated in OH- and/or OD-containing silica glass. Formulae (F1) and (F2) represent the partial structures of a silica glass prior to and after exposure to UV irradiation, respectively. It is believed that initially, prior to the exposure to UV light, Si—OY bonds are randomly arranged in the SiO₂ network and certain hydrogen bonds are formed. Exposure to UV light can provide enough allowing activation energy for —OY (or —Y) bond movement (other wavelengths may be affective if there is sufficient absorption). If the light is linearly polarized then those bonds aligned with the light's polarization are activated and can move (e.g., form a different hydrogen bond with the SiO₂ network), resulting in the breakage of previously existing hydrogen bonds and formation of new hydrogen bonds; thus creating a Polarization-Induced Birefringence (PIB) damage in the sample. The more SiOY in the sample the more PIB damage: we are predicting an approximate linear response with ppm OY in the silica.

FIG. 2 schematically illustrates a photochemical reaction possibly involved in the polarization-induced birefringence phenomenon in a manner slightly different from that of FIG. 1. As in FIG. 1, the mechanism involves the breakage of certain hydrogen bonds pre-existing in the partial glass structure (F3) prior to exposure and the formation of new hydrogen bonds in the partial glass structure (F4) after exposure. The reaction rate k(Y) of the photoreaction is k(H) and k(D), respectively, when the atom Y in the figure is H and D, respectively. It is hypothesized by the present inventors that, due to the significant mass difference between D and H (approximately 2 times difference), the reaction rate k(D) is significantly lower than k(H). Accordingly, all other conditions, such as the total quantity of OY in the glass, remaining equal, silica glass with higher n(OD)/(n(OD)+n(OH)) ratio is expected to have lower polarization-induced birefringence.

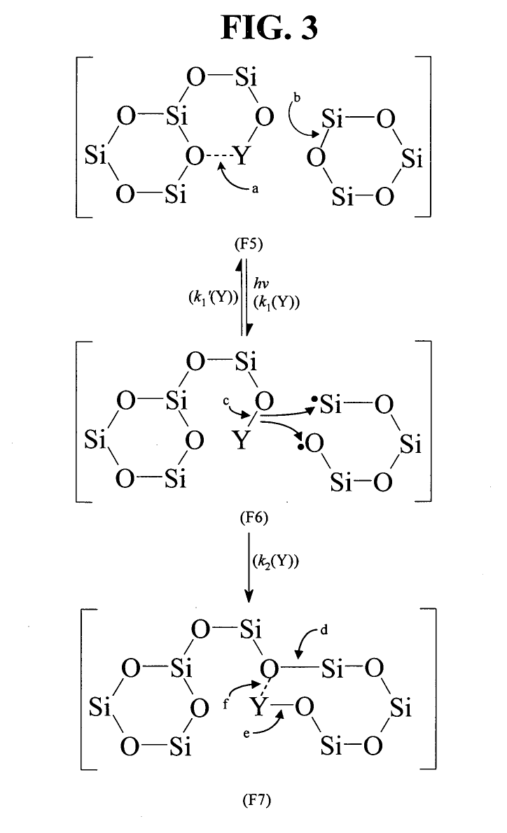

Furthermore, in FIG. 3, the present inventors propose another mechanism in an effort to account for both LIWFD and polarization-induced birefringence as a result of exposure to linearly or elliptically polarized UV irradiation. This proposed mechanism is essentially a two-step reaction involving the breakage and formation of both hydrogen bonds and covalent bonds. The first step, a photolysis reaction having a reaction rate of k₁(Y), involves the breakage of a covalent bond b (a Si—O bond) and possible breakage of a hydrogen bond a in the partial structure (F5) prior to exposure. The reverse reaction of this first step has a reaction rate of k′₁(Y). The second step, having a reaction rate of k₂(Y), involves the breakage of bond c (an O—Y bond) in an intermediate structure (F6), the formation of new bond d (a Si—O bond) and e (a Y—O bond), and possibly the formation of a new hydrogen bond f in the post-exposure partial structure (F7). Because (F5) is a less open and denser structure than F(7), the reactions result in a density change in the exposed area, hence LIWFD. It is hypothesized that both k₁(D)<k₁(H) and/or k₂(D)<k₂(H). Consequently, at essentially the same level of total OY concentration, silica glass with higher n(OD)/(n(OD)+n(OH)) ratio is expected to have lower polarization-induced birefringence, as well as lower LIWFD. Based on this hypothesis, silica glass doped with OY moieties (OD and/or OH) in which the oxygen atoms have higher proportions of ¹⁷O and ¹⁸O are expected to have lower level of polarization-induced birefringence and LIWFD as well. It may be possible in some applications to use other isotope of hydrogen, tritium (T), atoms in the preparation of the glass, thus forming OT-doped glass.

The OD-doped silica glass of the present invention is capable of being used in lithography below about 300 nm. It can be used in lithographic devices operating at longer wavelength, such as in the I-line lithography at about 365 nm. In certain preferred embodiments, the OD-doped silica glass of the present invention is capable of being used as refractive lens elements in the light path of the UV irradiation utilized in the dry lithographic devices operating at about 248 nm. In certain preferred embodiments, the OD-doped silica glass of the present invention has the composition and property requirements for use as refractive lens elements in the light path of the UV irradiation utilized in the immersion lithographic devices operating at about 248 nm. In certain other preferred embodiments, the OD-doped silica glass of the present invention is capable of being used as refractive lens elements in the light path of the UV irradiation utilized in the dry lithographic devices operating at about 193 nm. In certain preferred embodiments, the OD-doped silica glass of the present invention has the composition and property requirements for use as refractive lens elements in the light path of the UV irradiation utilized in the immersion lithographic devices operating at about 193 nm. One of ordinary skill in the art of lithography knows that for silica glasses to be used as lens elements in these applications, stringent requirements regarding optical performance such UV transmission, UV degradation in terms of induced absorption, light induced wavefront distortion (LIWFD), refractive index homogeneity, fictive temperature, birefringence, light induced birefringence, must satisfied. Ample literature has discussed the relationship between these required optical performance and the composition of the glass in terms of OH concentration and distribution, halogen concentration and distribution, alkali metal concentration and distribution, transition metal concentration and distribution, and the like. As discussed above, in a totally unexpected manner, the present inventors have discovered that high purity fused silica glass doped with OD has, inter alia, superior performance in polarization-induced birefringence when subjected to linear polarized irradiation. Therefore, the glass of the present invention, especially those doped with high ratio of OD, can be advantageously used in immersion lithographic technology. Of course, the OD-doped silica glass may be used as the material for lens elements in reflective lithography operating in the vacuum UV and X-ray spectrum. These applications have special requirements on the other physical properties of the glass.

The natural isotopic abundance of deuterium (D) is about 1.15×10⁻⁴ by mole. The OD-doped silica glass of the present invention has a n(D)/(n(D)+n(H)) higher than about 2×10⁻⁴, thus higher than the natural isotopic abundance of D. The synthetic silica glass material of the present invention may be essentially devoid of OH. However, it is not ruled out that it may contain a certain level of OH in the glass. Nonetheless, in certain preferred embodiments of the OD-doped synthetic silica glass of the present invention, it has an n(OD)/(n(OD)+n(OH)) ratio of higher than about 0.05, in certain embodiments preferably higher than about 0.5, in certain other embodiments preferably higher than about 0.8, in certain other embodiments preferably higher than about 0.90, in certain other preferred embodiments higher than about 0.95, in certain other embodiments preferably higher than about 0.99. It has been demonstrated by the present inventors that high purity synthetic silica glass with various levels of [OD] can be obtained by using the soot-to-glass method. High isotopic purity D₂O having a higher than 99.9% of n(D)/(n(D)+n(H)) may be employed in the soot-to-glass method of the present invention, to be described infra as one of the processes of the present invention, can be used to produce synthetic silica glass with n(OD)/(n(OD)+n(OH)) higher than 99%. When used with normal H₂O at various proportions, synthetic silica glass with various levels of n(OD)/(n(OD)+n(OH)) can be produced.

In the OD-doped synthetic silica glass of the present invention, in the OD and optionally OH moieties, the oxygen atoms may be ¹⁶O, ¹⁷O and ¹⁸O at their natural isotopic abundances. The natural isotopic abundances of these three isotopes, by mole, are 99.757%, 0.038% and 0.205%, respectively. As described supra, in certain preferred embodiments, the silica glass of the present invention may comprise higher percentage of ¹⁷O and ¹⁸O, especially ¹⁸O (a stable isotope), than their natural isotopic abundances.

In certain embodiments of the OD-doped silica glass of the present invention, the glass has an OH concentration of lower than about 600 ppm by weight, in certain preferred embodiments preferably lower than about 160 ppm, in certain other preferred embodiments lower than about 50 ppm, in certain other embodiments preferably lower than about 20 ppm, in certain other embodiments preferably lower than about 1 ppm, in certain other embodiments still preferably lower than 0.1 ppm.

In certain embodiments of the OD-doped synthetic silica glass of the present invention, the glass has an OD concentration of lower than about 1400 ppm by weight, in certain preferred embodiments lower than about 1000 ppm, in certain preferred embodiments lower than about 800 ppm, in certain other preferred embodiments lower than about 500 ppm, in certain other preferred embodiments lower than about 300 ppm, in certain other preferred embodiments lower than about 150 ppm, in certain other preferred embodiments lower than about 50 ppm, in certain other preferred embodiments lower than about 20 ppm, in certain other embodiments lower than about 1 ppm, in certain embodiments between about 0.1-1400 ppm, in certain other embodiments between about 0.1-1000 ppm, in certain embodiments between about 0.1-800 ppm, in certain other embodiments between about 0.1-500 ppm, in certain other embodiments between about 0.01-150 ppm, in certain other embodiments between about 0.01-50 ppm, in certain other embodiments between about 0.01-20 ppm.

In certain embodiments of the OD-doped synthetic silica glass of the present invention, the glass has less than about 500 ppm by weight of OH and 0.15-1400 ppm OD. In certain embodiments of the OD-doped synthetic silica glass of the present invention, the glass comprises less than about 150 pm by weight of OH and about 0.1-1400 pm OD. In certain other embodiments of the OD-doped synthetic silica glass of the present invention, the glass comprises less than about 20 ppm by weight of OH and 0.01-1400 ppm OD. In certain other embodiments of the OD-doped synthetic silica glass of the present invention, the glass comprises less than about 20 ppm by weight of OH and about 0.01-300 ppm OD.

In certain embodiments of the OD-doped synthetic silica glass of the present invention, the glass has an essentially constant ratio of concentration of OD ([OD]) to the concentration of OH ([OH]) in different locations in the glass, i.e., [OD]/[OH]. By “essentially constant ratio,” it is meant that the difference between the maximal ratio (Rₘₐₓ) and the minimal ratio (Rₘᵢₙ) as measured has the following relationship: 2(Rₘₐₓ−Rₘᵢₙ)/(Rₘₐₓ+Rₘᵢₙ)≦0.1. In certain embodiments, 2(Rₘₐₓ−Rₘᵢₙ)/(Rₘₐₓ+Rₘᵢₙ)≦0.05.

In certain embodiments of the OD-doped synthetic silica glass of the present invention, the glass has a [OD] variation, measured in a plane essentially perpendicular to the optical axis of the glass, of less than about 10 ppm by weight, in certain embodiments less than about 5 ppm, in certain other embodiments less than about 2 ppm, in certain other embodiments less than about 1 ppm, in certain other embodiments less than about 0.1 ppm. In certain embodiments of the OD-doped synthetic silica glass of the present invention, the glass has, in addition to the or in absence of the [OD] variation described in this paragraph, an [OH] variation, measured in a plane essentially perpendicular to the optical axis of the glass, of less than about 10 ppm by weight, in certain embodiments less than about 5 ppm, in certain other embodiments less than about 2 ppm, in certain other embodiments less than about 1 ppm.

The OD-doped synthetic silica glass of the present invention may be essentially free of dopants other than OD and OH. However, it is not ruled that the OD-doped synthetic silica glass of the present invention comprises dopants such as Al, F, Cl and Ti. The Ti-containing OD-doped silica glass of the present invention may be advantageously used in the substrates for reflective optical elements, especially those requiring high thermal dimensional stability, such as those used in reflective lithography technology operating in vacuum UV and X-ray spectra. F-doped silica glass of the present invention may comprise, for example, fluorine in the amount of less than 1000 ppm by weight, in certain embodiments less than about 500 ppm, in certain other embodiments less than about 300 ppm, in certain other embodiments less than about 100 ppm, in certain embodiments less than about 50 ppm, in certain other embodiments less than about 10 ppm. In certain embodiments of the OD-dopes silica glass of the present invention, it comprises less than about 150 pm by weight of OH, about 0.1-1400 pm by weight OD and about 1-500 ppm by weight F. In certain other embodiments of the OD-doped synthetic silica glass of the present invention, the glass comprises less than about 20 ppm by weight of OH, about 0.01-1400 ppm OD and about 1-500 ppm F. In certain other embodiments of the OD-doped synthetic silica glass of the present invention, the glass comprises less than about 20 ppm by weight of OH, about 0.01-300 ppm OD and about 1-500 ppm F.

The OD-doped synthetic silica glass may be doped with molecular H₂, HD and/or D₂. In certain preferred embodiments, the OD-doped synthetic silica glass of the present invention has a concentration of [H₂], [HD] and [D₂], in total, of between 5×10¹⁵ to 1×10¹⁹ molecules/cm³, in certain preferred embodiments below about 5×10¹⁸ molecules/cm³, in certain other preferred embodiments below about 5×10¹⁷ molecules/cm³, in certain other preferred embodiments below about 1×10¹⁷ molecules/cm³ in certain other preferred embodiments between about 1×10¹⁶ to 1×10¹⁷ molecules/cm³. In certain preferred embodiments of the OD-doped synthetic silica glass of the present invention, the ratio of (2n(H₂)+n(HD))/2(n(H₂)+n(HD)+n(D₂)) is higher than 0.1, in certain preferred embodiments higher than about 0.3, in certain other preferred embodiments higher than about 0.5, in certain other embodiment higher than about 0.7, in certain other preferred embodiments higher than about 0.9. In certain preferred embodiment, the ratio of (2n(H₂)+n(HD))/2(n(H₂)+n(HD)+n(D₂)) in the glass is essentially the natural isotopic abundance of H by mole. In certain other embodiments, the ratio of (2n(D₂)+n(HD))/2(n(H₂)+n(HD)+n(D₂)) is higher than 0.1, in certain preferred embodiments higher than about 0.3, in certain other preferred embodiments higher than about 0.5, in certain other embodiment higher than about 0.7, in certain other preferred embodiments higher than about 0.9. In certain preferred embodiment, the ratio of (2n(D₂)+n(HD))/2(n(H₂)+n(HD)+n(D₂)) in the glass is essentially the natural isotopic abundance of D by mole.

In certain embodiments of the OD-doped synthetic silica glass of the present invention, the glass has an essentially constant ratio of [D₂]/[H₂] at different locations of the glass. By “essentially constant ratio,” it is meant that the difference between the maximal ratio (R′ₘₐₓ) and the minimal ratio (R′ₘᵢₙ) as measured has the following relationship: 2(R′ₘₐₓ−R′ₘᵢₙ)/(R′ₘₐₓ+R′ₘᵢₙ)≦0.1. In certain embodiments, 2(R′ₘₐₓ−R′ₘᵢₙ)/(R′ₘₐₓ+R′ₘᵢₙ)≦0.05.

In certain embodiments of the OD-doped synthetic silica glass of the present invention, the glass has a concentration variation of OH and OD ([OH]+[OD]) measured in a plane perpendicular to at least one direction of less than about 50 ppm, in certain embodiments preferably less than about 30 ppm, in certain other embodiments preferably less than about 20 ppm, in certain other embodiments less than about 10 ppm, in certain other embodiments preferably less than about 1 ppm, in certain other embodiments preferably less than about 0.1 ppm.

In certain embodiments of the OD-doped silica glass of the present invention, the glass has a Cl concentration less than about 100 ppm, in certain embodiments less than about 50 ppm, in certain other embodiments less than about 10 ppm.

It is known that high purity synthetic silica glass material are required to have a very low level of alkali metals, alkaline earth and transition metals in order to have a sufficient transmission properties (e.g., absorption, induced absorption, fluence-dependent-transmission, birefringence, light-induced birefringence, LIWFD, and the like) in the wavelength of interest in the UV, such as for use as refractive members in KrF and ArF lithography devices. Certain metals having multiple oxidation states can cause more absorption at one oxidation state than at others. Thus, in certain embodiments of the OD-doped silica glass of the present invention, the glass comprises less than 50 ppb by weight, in certain embodiments preferably less than about 20 ppb, in certain other embodiments preferably less than about 10 ppb, of any alkali metal, any alkali earth metal, and any transition metal. In certain embodiments, the glass comprises any transition metal at less than 2 ppb. In certain other embodiments, the glass comprises any transition metal at less than 1 ppb. In certain other embodiments, the glass comprises any transition metal at less than 0.5 ppb. In certain embodiments, especially for glasses to be used as refractive optical member in ArF laser lithography devices, it is preferred that the glass comprises any individual element in all oxidation states of the following in concentrations less than 2 ppb by weight, in certain embodiments preferably less than 1 ppb, in certain other embodiments less than 0.5 ppb, in certain other embodiments less than 0.1 ppb: Ti (+2, +4, for example), V (+5, +4, for example), Cr (+6, +3, for example), Mn (+6, +4, +2, for example), Fe (+3, +2, for example), Co (+3, +2, for example), Ni (+2, for example), Cu (+2, +1, for example), Zn (+2, for example), Ge (+4, +2, for example), Zr (+4, for example), Ag (+1, for example), Cd (+1, for example), Sn (+4, +2, for example), Pb (+4, +2, for example), Bi (+5, +3, for example) and U (+6, +3, for example). Of course, elemental metals (in 0 state) are generally detrimental to the transmission properties of the glass. In certain embodiments of the OD-doped synthetic silica glass of the present invention, it comprises less than 50 ppb by weight, in certain embodiments preferably less than 30 ppb, in certain other embodiments preferably less than 10 ppb, of any and all metals in all oxidation states in total. Similar low levels of such elements are also desired for OH-doped lithographic silica glass and F-doped lithographic silica glass.

In certain preferred embodiments of the OD-doped synthetic silica glass of the present invention, the glass exhibits a light-induced wavefront distortion (LIWFD), measured at 633 nm, of between −0.1 and 0.1 nm/cm, in certain preferred embodiments between −0.5 to 0.5 nm/cm, in certain other preferred embodiments between about 0 and 1 nm/cm, in certain other preferred embodiments between about 0 and 0.5 nm/cm, when subjected to 10 billion pulses of a laser beam operating at approximately 193 nm and having a fluence of approximately 70 μJ/(cm·pulse) and a pulse length of approximately 25 ns.

In certain embodiments of the OD-doped synthetic silica glass of the present invention, the glass exhibits, in addition to or in absence of the LIWFD properties described above, a normalized wavefront distortion L633 when subjected to excimer laser pulses at about 193 nm of less than or equal to about 20 billion pulses, measured at about 633 nm, wherein 0≦L633≦1.0, in certain preferably embodiments 0≦L633≦0.5, in certain other preferred embodiments 0≦L633≦0.4, in certain other embodiments preferably 0≦L633≦0.3.

In certain embodiments of the OD-doped synthetic silica glass of the present invention, the glass exhibits, in addition to or in absence of the LIWFD and L633 properties described above, a normalized wavefront distortion L193 when subjected to excimer laser pulses at about 193 nm of less than or equal to about 20 billion pulses, measured at about 193 nm, wherein 0≦L193≦1.0, in certain embodiments preferably 0≦L1 93≦0.5, in certain embodiments preferably 0≦L193≦0.4, in certain other embodiments preferably 0≦L193≦0.3.

In certain embodiments of the OD-doped synthetic silica glass of the present invention, the glass exhibits less than about 1 nm/cm, in certain embodiments preferably less than 0.1 nm/cm, of polarization-induced birefringence (magnitude) measured at about 633 nm after being subjected to 5×10⁹ pulses of linearly polarized pulsed laser beam at about 193 nm having a fluence of about 40 μJ·cm⁻²·pulse⁻¹ and a pulse length of about 25 ns. In certain other embodiments of the OD-doped synthetic silica glass of the present invention, the glass exhibits less than about 1 nm/cm, in certain embodiments preferably less than 0.1 nm/cm, of polarization-induced birefringence (magnitude) measured at about 633 nm after being subjected to 1×10¹⁰ pulses of linearly polarized pulsed laser beam at about 193 nm having a fluence of about 40 μJ·cm⁻²·pulse⁻¹ and a pulse length of about 25 ns. In certain embodiments of the OD-doped synthetic silica glass of the present invention, the glass exhibits less than about 0.1 nm/cm of polarization-induced birefringence (magnitude) measured at about 633 nm after being subjected to 2×10¹⁰ pulses of linearly polarized pulsed laser beam at about 193 nm having a fluence of about 40 μJ·cm⁻²·pulse⁻¹ and a pulse length of about 25 ns. In certain embodiments of the OD-doped synthetic silica glass of the present invention, the glass exhibits less than about 0.04 nm/cm of polarization-induced birefringence (magnitude) measured at about 633 nm after being subjected to 2×10¹⁰ pulses of linearly polarized pulsed laser beam at about 193 nm having a fluence of about 40 μJ·cm⁻²·pulse⁻¹ and a pulse length of about 25 ns. In certain embodiments of the synthetic silica glass of the present invention, the glass exhibits higher than about 0.001 nm/cm of polarization-induced birefringence (magnitude) measured at about 633 nm after being subjected to 2×10¹⁰ pulses of linearly polarized pulsed laser beam at about 193 nm having a fluence of about 40 μJ·cm⁻²·pulse⁻¹ and a pulse length of about 25 ns. In certain embodiments of the OD-doped synthetic silica glass of the present invention, the glass exhibits higher than about 0.01 nm/cm of polarization-induced birefringence (magnitude) measured at about 633 nm after being subjected to 2×10¹⁰ pulses of linearly polarized pulsed laser beam at about 193 nm having a fluence of about 40 μJ·cm⁻²·pulse⁻¹ and a pulse length of about 25 ns.

In certain embodiments of the OD-doped synthetic silica glass of the present invention, the glass exhibits a normalized polarization-induced birefringence less than 10, in certain embodiments less than 5, when subjected to excimer laser pulses at about 193 nm of less than or equal to about 20 billion pulses.

In certain embodiments of the OD-doped silica glass of the present invention, the glass exhibits a polarization-induced birefringence less than about 0.04 nm/cm, in certain embodiments less than about 0.02 nm/cm of polarization-induced birefringence measured at about 633 nm after being subjected to 2×10⁹ pulses of linearly polarized pulsed laser beam at about 193 nm having a fluence of about 200 μJ·cm⁻²·pulse⁻¹ and a pulse length of about 25 ns, in certain embodiments less than about 0.02 nm/cm of polarization-induced birefringence measured at about 633 nm after being subjected to 5×10⁹ pulses of linearly polarized pulsed laser beam at about 193 nm having a fluence of about 200 μJ·cm⁻²·pulse⁻¹ and a pulse length of about 25 ns.

In certain embodiments of the OD-doped silica glass of the present invention, the glass exhibits a normalized polarization-induced birefringence less than 2, in certain embodiments less than 1, in certain embodiments less than 0.5, when subjected to excimer laser pulses at about 193 nm of less than or equal to about 2 billion pulses. In certain embodiments, the glass exhibits a normalized polarization-induced birefringence less than 2, in certain embodiments less than 1, in certain embodiments less than 0.5, when subjected to excimer laser pulses at about 193 nm of less than or equal to about 5 billion pulses. In certain other embodiments, the glass exhibits a normalized polarization-induced birefringence less than 2, in certain embodiments less than 1, in certain embodiments less than 0.5, when subjected to excimer laser pulses at about 193 nm of less than or equal to about 8 billion pulses.

In certain embodiments of the OD-doped synthetic silica glass of the present invention, the glass exhibits an initial internal transmission at about 193 nm of at least 99.65%/cm, in certain embodiments preferably at least 99.75%/cm, in certain other embodiments preferably at least 99.80%/cm.

In certain embodiments of the OD-doped synthetic silica glass of the present invention, the glass exhibits a fictive temperature of lower than about 1150° C. In certain other embodiments of the OD-doped synthetic silica glass of the present invention, the glass exhibits a fictive temperature of lower than about 1000° C. In certain embodiments of the glass of the present invention, it exhibits a fictive temperature of higher than about 800° C.

In certain embodiments of the OD-doped synthetic silica glass of the present invention, the glass exhibits a refractive index variation measured in a plane perpendicular to at least one direction of less than about 10 ppm, in certain embodiments preferably less than about 5 ppm, in certain other embodiments preferably less than about 2 ppm, in certain other embodiments preferably less than about 1 ppm, in certain other embodiments preferably less than about 0.5 ppm.

Another aspect of the present invention is an optical glass member comprising the OD-doped synthetic silica glass material of the present invention described in general and in detail above and illustrated below. The optical glass member advantageously is used in the light path of an irradiation having a wavelength of shorter than about 300 nm, though the glass member of the present invention may be used in the light path of irradiation having a longer wavelength, such as in the visible spectrum, or in the infrared spectrum. The OD-doped glass of the present invention is particularly advantageous for use in certain infrared applications where OH is undesirable and OD is acceptable. Non-limiting examples of such glass member of the present invention may include, but are not limited to, optical members for use as refractive lens elements, sputter targets, and the like. The refractive lens elements may be used in, e.g., lithographic scanners and steppers machines, laser generators, laser etalons, lithographic inspection devices, and the like. The OD-doped glass optical member of the present invention is particularly suited for devices involving high-fluence irradiations due to its improved laser damage resistance.

Still another aspect of the present invention is a lithographic system comprising at least one optical member of the present invention. The lithographic system is advantageously an immersion system in which at least one lens element is allowed to contact a liquid. Emersion lithographic systems usually utilize linearly polarized irradiation. Due to the high resistance to polarization-induced birefringence damage, the OD-doped synthetic silica glass member of the present invention is particularly suitable for such lithographic systems. Due to the excellent performance of the OD-doped glass material of the present invention, as mentioned supra, it may be used in traditional dry lithographic tools operating below about 300 nm, such as at about 248 nm, 193 nm and 157 nm.

The OD-doped synthetic silica glass material of the present invention may be produced by using various methods, such as the direct-to-glass method, the soot-to-glass methods and the sol-gel processes, to name a few. Generally, the OD-doped silica glass of the present invention may be produced by: (i) utilizing D-exchanged or D-enriched starting materials to produce silica; (ii) making silica glass in a D-rich environment; and (iii) doping silica glass with OD.

The first method contemplated by the present inventors is a direct-to-glass method. Broadly speaking, this process includes the following steps:

(I) providing a plurality of particles comprising silica;

(II) depositing the plurality of particles on a supportive deposition surface at an elevated temperature such that the particles are consolidated into transparent glass material in situ,

wherein:

in step (II), the deposition and consolidation are carried out in an D-containing atmosphere, such that the obtained silica glass comprises OD and optionally OH, and the ratio of n(OD)/(n(OD)+n(OH)) is higher than about 2×10⁻⁴, in certain embodiments preferably higher than about 0.1, in certain other embodiments higher than about 0.3, in certain other embodiments higher than about 0.5, in certain other embodiments higher than 0.8, in yet still other embodiments higher than about 0.9, in certain other embodiments higher than about 0.95.

In step (I), the plurality of particles comprising silica may be provided by flame hydrolysis of at least one precursor compound comprising silicon, such as silicon halides or organosilicon compounds. As non-limiting example of organosilicon compound, mention may be made of octamethylcyclotetrasiloane (OMCTS). The precursor compound may comprise D at a level higher than its natural isotopic abundance (such as D-containing OMCTS), in which case the particle per se is usually OD-doped when originally produced. Alternatively, the precursor compound may comprise D at a level no more than its natural isotopic abundance, yet the precursor compound is allowed to undergo flame hydrolysis in an atmosphere comprising D at a level higher than its natural isotopic abundance, such as an atmosphere comprising added D₂O or D₂O produced from burning D-containing compound as fuel, such as CD₄, CDH₃, CD₂H₂, D₂, HD, and the like. The particle comprising silicon may be pre-fabricated or produced in situ in the same furnace where they are deposited and consolidated in step (II). Where they are pre-fabricated, they may be provided in step (I) via a soot gun, sprayed to the supportive deposition surface and allowed to consolidate. If the pre-fabricated particles are D-containing, step (II) may be carried out in an environment that is D-containing or not, depending on the level of OD in the pre-fabricated particles and the desired level of OD in the final consolidated glass. If the pre-fabricated particles are not D-containing, step (II) should be carried out in a D-containing environment (such as in the presence of D₂O gas) in order to introduce D into the consolidated glass. This direct-to-glass method for making the OD-doped silica glass of the present invention may be plasma-assisted. By adjusting the ratio of n(D)/(n(D)+n(H)) in the atmosphere in which the particles are produced, and in the atmosphere in step (II) is carried out, one can produce OD-doped final glass with desired level of OD-doping.

There is abundant literature on equipment and processes for making high-purity fused silica material by using the direct-to-glass method, which can be adapted for making high-purity OD-doped fused silica glass of the present invention. For example, it is highly desired that the supportive deposition surface in step (II) is an essentially planar deposition surface of a horizontal rotating table. Generally, in order to obtain OD-doped fused silica glass for use in deep UV and vacuum UV lithographic devices, the glass should be produced in a very clean environment, and care should be taken to avoid contamination by metals detrimental to the desired properties. However, as in the case of producing regular non-OD-doped high purity fused silica, where desired, it is also possible to dope the OD-doped synthetic silica glass material with various dopants, such as F, Al, Ti, and the like, in a direct-to-glass furnace. Where the particles in step (I) are pre-fabricated, they may have essentially the same composition or differing compositions (e.g., certain particles comprising dopants and particles essentially free of dopants can be mixed and provided in step (I)).

The consolidated glass produced in step (II) may be further subjected to the following step:

(III) treating the consolidated glass obtained in step (II) in an atmosphere comprising H₂ and/or HD and/or D₂.

The purpose of step (III) is to adjust the level of molecular hydrogen (H₂, HD and/or D₂) to a desired level. Hydrogen molecules doped at desired level in the glass can improve the optical performance of the material. Such hydrogen-treatment is desired to be conducted below about 600° C. In certain cases it may be desired to be conducted at above about 600° C. Generally, it is desired that it is carried out at below about 1000° C. Generally, it is desired that the treatment time and temperature of step (III) is chosen such that the sum total of the concentration of H₂, HD and D₂ in the treated glass is between about 0.5×10¹⁶ to about 5×10¹⁹ molecules/cm³, in certain embodiments preferably from about 0.5×10¹⁶ to about 5×10¹⁸ molecules/cm³, in certain other embodiments preferably from about 1×10¹⁶ to about 1×10¹⁸ molecules/cm³. In certain embodiments, it is desired that the atmosphere in which step (III) is D-containing, i.e., the atmosphere has a ratio of (2n(D₂)+n(HD))/2(n(H₂)+n(D₂)+n(HD)) higher than the natural isotopic abundance of D. It is also desired that after step (III), the ratio of [D₂]/[H₂] at different locations in the glass is essentially constant, i.e., the distribution profiles of D₂ and H₂ are essentially the same (though maybe at differing concentrations). However, to lower the cost, it may be desired that in step (III), the atmosphere is essentially non-D-containing, i.e., the atmosphere has a ratio of (2n(H₂)+n(HD))/2(n(H₂)+n(D₂)+n(HD)) higher than the natural isotopic abundance of H.

Another method of the present invention for making OD-doped synthetic silica glass of the present invention, termed “particle-to-glass” herein, involves the formation of a porous particle preform. This method comprises the following steps:

(A) providing a particle preform comprising a plurality of particles comprising silica;

(B) optionally purifying and/or drying the particle preform;

(C) optionally further doping the particle preform with dopants;

(D) consolidating the particle preform at an elevated temperature to dense glass; and

(E) optionally treating the consolidated glass obtained in step (D) in the presence of H₂, HD and/or D₂,

wherein in at least one of steps (A), (B), (C), (D) and (E), OD is introduced or formed into the glass. Generally, it is preferred that in at least one of steps (A), (B), (C) and (D), OD is introduced into the glass.

In one embodiment of this process, step (A) comprising the following steps:

(A1) providing a plurality of particles; and

(A2) depositing the particles on a supporting surface to form the particle preform. The supporting surface is preferred to be rotating in certain embodiments.

In step (A1), the particles may be provided by (A1.1) flame hydrolysis of at least one silicon-containing precursor compound, which may be plasma-assisted; or (A1.2) a soot gun, which may be plasma-assisted; or (A1.3) other plasma-assisted process. In the present application, the particle-to-glass process involving step (A1.1) is termed “soot-to-glass” process. Soot-to-glass process for making regular non-OD-doped high-purity fused silica glass is described in, for example, co-pending, co-assigned patent application Ser. No. 11/148,764, entitled “HIGH REFRACTIVE INDEX HOMOGENEITY FUSED SILICA GLASS AND METHOD OF MAKING SAME” and filed on Jun. 8, 2005, the relevant part of which is incorporated herein by reference.

Particles provided by step (A1.1) may be OD-doped or non-OD-doped. Where D-containing compounds are used in the flame hydrolysis process, the particles provided are usually OD-doped. If the atmosphere of the flame hydrolysis process of step (A1.1) comprises D₂O, the particles thus provided are usually OD-doped. co-pending, co-assigned patent application Ser. No. 11/148,764, entitled “HIGH REFRACTIVE INDEX HOMOGENEITY FUSED SILICA GLASS AND METHOD OF MAKING SAME” and filed on Jun. 8, 2005, the relevant part of which is incorporated herein by reference.

Step (A2) can be carried out by various methods such as (A2.1) outside vapor deposition; (A2.2) inside vapor deposition; (A2.3) vapor axial deposition; (A2.4) planar deposition, and the like. There is abundance literature describing these methods for making regular non-OD-doped glass comprising silica, which can be adapted for making the OD-doped synthetic silica glass of the present invention.

The sol-gel process may be employed in step (A) to produce the particle preform, which comprises the following steps:

(A(i)) forming a sol-gel comprising silica; and

(A(ii)) forming the particle preform from the sol-gel.

Step (A(i)) may be carried out in the presence or from at least one D-containing compound. In particular, step (A(i)) may be carried out in the presence of D₂O. For example, the sol-gel can be produced by the hydrolysis of a silicon-containing precursor compound (such as siloxane) in liquid D₂O. Thus the particle preform produced in step (A) comprises OD-doped silica particles. There is abundant literature describing methods for making non-OD-doped glass comprising silica via the sol-gel process, which can be adapted for making the OD-doped synthetic silica glass of the present invention. Typically, the sol-gel process includes a step of hydrolysis of a silicon-containing precursor compound (such as a silane, siloxane, or polysiloxane) in an aqueous media to produce a sol-gel of silica. The sol-gel can then be cast into a green body, which is a form of the particle preform in the meaning of the present application. The green body may be partially dried before further processing in subsequent steps (B)-(E).

Particle preforms produced by flame hydrolysis and sol-gel processes may comprise undesirably high amount of OH and OD. Particle preforms produced from sol-gel process may even comprise substantial amounts of H₂O and/or D₂O. Particle preforms (typically called soot preforms) produced by flame hydrolysis methods mentioned above (IVD, OVD, VAD, PD) involving the burning of fuels comprising H and/or D (H₂, D₂, CH₄, CDH₃, and the like, for example) and/or precursor compounds comprising H and/or D (OMCTS, for example) typically comprise in the soot particles OH and OD groups. For many applications, such amounts of OH and/or OD in the preform would lead to undesirably high level of OH and/or OD in the consolidated glass for the intended purposes. For example, it is understood by the present inventor that low OH/OD glass, such as those comprising a total concentration of OH and OD of less than 500 ppm, in certain embodiments preferably lower than 300 ppm, in certain embodiments preferably lower than about 150 ppm, in certain embodiments preferably lower than about 50 ppm, may be desired for high purity silica glass for use in optical members used in UV and deep UV lithography devices.

For those particle preforms with undesirably high level of H₂O, D₂O, OH and/or OD, it is desired that before it is further optionally doped with additional dopants, and before it is consolidated into dense glass, it is at least dried to lower the OD and/or OD concentration to a desirable level. In order to control the final OH and/or OD concentration in the consolidated glass, it is desirable in many cases that the particle preform is dried to have a total concentration of OH and/or OD below about 50 ppm by weight, in certain embodiments preferably below about 10 ppm, in certain other embodiments preferably below about 1 ppm, in certain other embodiments preferably below about 0.01 ppm. Where a particle preform comprises below about 1 ppm by weight of total OH and/or OD, the particle preform is considered essentially dry for the purpose of the present application.

Drying agents such as dry inert gas, including but not limited to He, Ar, N₂, and the like, may be used to reduce the H₂O, D₂O, OH and/or OD in the particle preform, at an elevated temperature, such as higher than 500° C., in certain embodiments higher than about 800° C. CO, CO₂, and the like, may be used as drying agent as well. CO may react with silica particles to produce defects in the glass. Such defects may be healed as described infra. Preferred drying agents are F₂, Cl₂, Br₂, halogen compound, CO, CO₂, and compatible mixtures thereof. The halogen compound is preferably selected from HX, COX₂, SOX₂, CX₄ and SX₆, where X is selected from F, Cl, Br and combination thereof. The most preferred drying agent is Cl₂ and Br₂, and mixtures thereof.

The particle preform as provided in step (A) may contain contaminants, especially detrimental metal ions, at unacceptably high amounts. Once the glass is consolidated and the contaminants are incorporated into the consolidated into the glass, their removal becomes difficult. Therefore, it is highly desirable that prior to consolidation, where necessary, the particle preform is subjected to purification such that contaminant concentrations are reduced to a desired level prior to consolidation of the preform.

Many of the drying agents for removing H₂O, D₂O, OD and/or OH from the particle preform has contaminant stripping function as well. Those drying agents, when used in the drying process, may function to purify the particle preform simultaneously. Therefore, drying and purifying may advantageously be carried out at the same time, or if desired, different agents may be used to achieve these two achieve these two different functions. Preferred purifying agents include, but are not limited to, Cl₂, F₂, Br, a halogen-containing compound, CO, CO₂, and the like. The halogen-containing compound may be HX, COX₂, SOX₂, CX₄ and SX₆, and the like, where X is selected from F, Cl, Br and combination thereof. The most preferred drying agent are Cl₂ and Br₂, and compatible mixtures thereof.

The particle preform may be further doped in step (C) prior to consolidation in step (D). It is also generally understood that doping dopants into consolidated glass is difficult, while doping particle preforms can be carried out in a controlled manner. Thus, the particle preform, with or without the drying/purifying step (B), may be further doped with dopants such as OD, OH, F, Cl, and the like. Doping at elevated temperature such as higher than 500° C., in certain embodiments higher than about 800° C., is desirable in order to expedite the doping process. By controlling the doping temperature, the concentration of the dopants in the doping atmosphere, and doping time, one can control the final concentration of the desired dopants in the particle preform, hence the concentration of the desired dopants in the final consolidated glass. To dope the particle preform with F, F-containing compounds such as HF, COF₂, SOF₂, SiF₄, CF₄ and SF₆. Therefore, during the drying and/or purifying step (B), the doping of F may be carried out. To dope the particle preform with C₁, Cl₂ and Cl-containing compounds such as HCl, COCl₂, SOCl₂ and CCl₄ may be used. Therefore, during the drying and/or purifying step (B), the doping of Cl may be carried out. Thus steps (B) and (C) may be carried out at least partially simultaneously.

For the purpose of the present invention, controlling the concentration of OH and/or OD in the consolidated glass is highly desirable for many applications, as mentioned supra. This can be desirably done in steps (B) and/or (C). For example, in step (B), the particle preform can be dried and purified to a level essentially free of OH and/or OD. Subsequently, in step (C), the dried particle preform is controllably doped with OH and/or OD to a desirable level so that the final consolidated OD-doped glass has the desired OD and/or OH concentrations. Doping is desirably effected at an elevated temperature such as higher than 500° C., in certain embodiments higher than about 800° C. By choosing the proper doping time, doping temperature, concentration of dopants in the doping atmosphere, one can control not only the final OD and/or OH concentration, but also achieve a homogeneous distribution thereof, and other dopants, in the consolidated glass. To dope the particle preform with OD and/or OH, OD-containing and/or OH-containing compounds may be used at various partial pressures in the doping atmosphere. For example, to dope the particle preforms with OD, the doping atmosphere may comprise D₂, HD, D₂O, CH₃OD, C₂H₅OD, CH₃COOD, and other OD-containing compounds. When D₂ and/or HD are present in the doping atmosphere, they may react with the SiO₂ glass to produce Si—OD and/or Si—OH in the glass. To dope the particle preforms with OH, the doping atmosphere may comprise H₂, HD, H₂O, CH₃OH, C₂H₅OH, CH₃COOH, and other OH-containing compounds. Similarly, when H₂ and/or HD are present in the doping atmosphere, they may react with the SiO₂ glass to produce Si—OH and/or Si—OD in the glass. It is known that reaction between hydrogen gas (D₂, DH and/or H₂) and SiO₂ can lead to the formation of oxygen-deficient sites in the silica glass. Thus, as described infra it is desired that the particle preform is treated in an oxidizing atmosphere to heal the defects before or during consolidation of the particle preform into dense glass if hydrogen gas is used as a doping agent in the doping atmosphere. If D₂O and/or H₂O are used as the doping agent in the doping atmosphere, they may be fed as they are into the doping environment, or formed in situ from, e.g., by reactions between D₂/H₂ and O₂ fed into the environment separately. To achieve the desired [OD]/[OH] ratio in the final consolidated glass, in the doping step (C), the doping atmosphere may be adjusted to contain the OD-containing and OH-containing compounds having the desired partial pressures thereof. The most preferred OD-doping agent for the particle preform is D₂O. D₂O at higher than 99.9% by mole of isotopic purity is commercially available. The most preferred OH-doping agent for the particle preform is H₂O. When doping essentially dry particle preform, the doping atmosphere may be adjusted to have the desired D₂O and H₂O partial pressures to obtain the desired [OD] and [OH] concentration in the final glass. When doing particle preforms comprising OH at a certain level with OD, the particle preform may be treated in a doping atmosphere comprising a D-containing compound, such as an OD-containing compound, such as D₂O, for a sufficient time, such that a desirable amount of OH in the particle preform is exchanged by OD. By controlling the partial pressure ratio of the OD-containing and OH-containing compounds in the doping atmosphere, doping temperature and doping time, glass with desired levels of [OD] and [OH] can be obtained in this manner as well. It is not ruled out that the particle preform may comprise certain amount of OD before step (C), and in step (C), it is doped or exchanged with OH only to achieve the desired [OD] and [OH] concentrations in the final glass. Ratio of n(OD)/(n(OD)+n(OH)) in the particle preform higher than about 0.02, in certain embodiments higher than about 0.05, in certain other embodiments higher than about 0.1, in certain other embodiments higher than about 0.3, in certain other embodiments higher than about 0.5, in certain other embodiments higher than about 0.9, in certain other embodiments higher than about 0.95, can be achieved.

The doping atmosphere may comprise, in addition to doping compounds, O₂, and inert gases. Since doping of OH and OD is usually carried out at elevated temperature such as higher than about 500° C., in certain embodiments higher than about 800° C., H₂, D₂, HD, O₂, H₂O and D₂O exist at amounts typically determined by chemical equilibrium and dynamic factors. Steps (B) and/or (C) may be carried out in the presence of other reductive gases than H₂ and D₂, such as hydrocarbons, D-containing hydrocarbons, and the like.

It is known that when particle preforms comprising silica is treated in a reductive atmosphere at an elevated temperature such as in steps (B) and/or (C), oxygen-deficient defects in the glass may be generated. Such defects are particularly detrimental for transmission properties in deep UV and vacuum UV, such as at about 248 nm and 193 nm. Therefore, after steps (B) and (C), it is highly desirable that the particle preform is treated in an oxidative atmosphere in a step (C(A)). The oxidation agent in the oxidative atmosphere may be, for example, O₂, O₃, D₂O, H₂O, and the like.

In step (D) of the process of the present invention, the particle preform is consolidated into dense silica glass. Steps (C) and (D) may be carried out at least partially simultaneously, meaning that, at least part of the doping is carried out while the particle preform is consolidated into dense glass. Step (C(A)) described above and step (D) may be carried out at least partly simultaneously, meaning that, at least in part of step (D), at least part of the oxygen-deficient defects in the glass is oxidized and healed. In step (D), the particle preform is heated to an elevated temperature, desirably higher than 1000° C., in certain embodiments higher than 1200° C., in certain embodiments higher than about 1400° C., where the particles are sintered into dense glass. Temperature elevation rate during consolidation step (D) may be controlled in a manner such that a homogeneous distribution of dopants such as OH, OD, F and the like is achieved. Step (D) may be conducted in a consolidation atmosphere comprising inert gas such as He, Ar, N₂, and the like. The consolidation atmosphere may further comprise O₂ and/or D₂O and/or H₂O at a desired level. The O₂, D₂O and/or H₂O can function to oxidize and heal the oxygen-deficient sites in the glass. Where high [OD] glass is desired, the consolidation atmosphere may be essentially devoid of H₂O and HDO. The consolidation atmosphere may further comprise H₂, D₂, HD, and the like. However, as mentioned above, reaction between such reductive gases with silica glass at elevated temperature can lead to the formation of defects in the glass. It is believed by the present inventors that glasses with high [OH] and/or [OD] tend to have less defects than glasses with lower [OH] and [OD] when treated in a reductive atmosphere at high temperature, such as an atmosphere comprising H₂, HD and/or D₂.

Step (E) of this process of the present invention involves hydrogen doping the consolidated glass with a hydrogen doping atmosphere comprising molecular H₂, HD and/or D₂. The hydrogen doping atmosphere may comprise essentially no D₂ and HD even for glasses doped with high percentages of OD, especially if the hydrogen loading temperature is relatively low, such as below about 500° C. In certain embodiments it is desired that for glasses doped with high percentage of OD, the hydrogen doping atmosphere is essentially devoid of HD and H₂ where the hydrogen doping temperature is higher than 500° C. Nonetheless, it has been found that where the silica glass is loaded at a temperature below about 500° C., the loading of H₂ or D₂ does not appreciably alter the [OH] and [OD] in the glass. The hydrogen doping may be advantageously carried out at a temperature below about 600° C. (cold loading), or to expedite the process, at a temperature above about 600° C. (hot loading). However, it is usually conducted at a temperature below 1000° C. Due to the laws of diffusion, to reach the same loaded hydrogen level in the glass, cold loading tends to take longer time. Nonetheless, cold loading is preferred for the production of certain silica glass, especially those with relatively low water (e.g., [OD]+[OH]<100 ppm) for use in refractive lens elements in deep UV and vacuum UV lithographic devices, because it tends to generate less defects in the consolidated glass.

As mentioned supra, it was stated in the copending, co-assigned patent application Ser. No. 11/241,075 (filed on Sep. 30, 2005 and entitled “SYNTHETIC SILICA HAVING LOW POLARIZATION-INDUCED BIREFRINGENCE, METHOD OF MAKING SAME AND LITHOGRAPHIC DEVICE COMPRISING SAME,” the relevant part thereof is incorporated herein by reference) that in non-OD-doped tends to have worse polarization-induced birefringence performance at higher [OH]. It was also stated in this patent application that the amount of polarization-induced birefringence was approximately proportional to the [OH] in an OH-doped silica glass. Therefore, for the sake of acceptable polarization-induced birefringence performance, for non-OD-doped synthetic silica glass, it is generally preferred that it has an [OH] of less than 500 ppm, in certain embodiments preferably less than 160 ppm, in certain other embodiments less than 50 ppm. However, in a totally unexpected manner, the present inventors have found that [OD]-doped silica glass, especially those essentially free of OH, tends to have much lower polarization-induced birefringence value compared to non-OD-doped silica glass with comparable [OH]. In certain OD-doped glass samples essentially devoid of OH, the polarization-induced birefringence was discovered to be essentially zero when exposed to 193 nm pulses of linearly polarized excimer laser beam at about 200 μJ·cm⁻²·pulse⁻¹ even after 8 billion pulses. Therefore, the present inventors expect that the OD-doped high purity synthetic silica glass of the present invention, especially those essentially devoid of OH will exhibit very low polarization-induced birefringence even with a high [OD] up to or exceeding 1000 ppm.

In a second co-pending, co-assigned patent application Ser. No. 11/261,005 (filed on Oct. 26, 2005 and entitled “SYNTHETIC SILICA WITH LOW FLUENCE-DEPENDENT-TRANSMISSION AND METHOD OF MAKING THE SAME,” the relevant portion thereof is incorporated herein by reference), it was found that for non-OD-doped high purity synthetic silica glass, from the standpoint of fluence-dependent-transmission (“FDT”) and LIWFD, it is preferable that for those with [OH]≦160 ppm, H₂ loading should be conducted at lower than about 600° C. It was shown that hot loading can cause deterioration in FDT and LIWFD in such OH-doped silica glass with [OH]≦160 ppm. Yet, it was also shown that for those with [OH]≧500 ppm, hot loading does not alter the FDT and LIWFD performance more appreciably than cold loading.

Therefore, the present inventors expect that the OD-doped synthetic silica glass of the present invention, especially those with essentially no OH, even with [OD] up to or exceeding 1000 ppm, can be hot loaded with hydrogen to result in glass with acceptable polarization-induced birefringence performance and without compromising the FDT and LIWFD properties. Therefore, high [OD] silica glass, at least those essentially free of OH, may be useable in applications where non-OD-doped silica glasses with comparable [OH] cannot be used. These high [OD] glasses can be produced with much higher efficiency and speed because it can be hot loaded, compared to the non-OD-doped, low [OH] glasses, which are typically required to be cold loaded.

Another method of making the OD-doped synthetic silica glass of the present invention includes the following steps:

(a) providing a plurality of OD-doped particles comprising silica; and

(b) melting the particles at an elevated temperature to obtain a transparent glass.

Step (a) in this process may comprise the following steps:

(a1) generating a plurality of particles comprising silica;

(a2) optionally purifying and/or drying the particles;

(a3) optionally doping the particles in an atmosphere comprising at least one D-containing compound, and

(a4) optionally treating the particles in an oxidative atmosphere to at least partly heal oxygen-deficient sites in the particles.

wherein at least in one of steps (a1), (a2), (a3) and (a4), OD moieties are introduced into the particles.

In step (a1), the particles comprising silica may be generated by flame hydrolysis or sol-gel processes as described above in connection with the particle-to-glass process wherein the particle preforms are finally consolidated instead of melted to form the glass.

In step (a2), the purifying and/or drying may be carried out mutatis mutandis as described above in connection with the particle-to-glass process wherein the particle preforms are finally consolidated instead of melted to form the glass.

In step (a3), the doping may be carried out mutatis mutandis as described above in connection with the particle-to-glass process wherein the particle preforms are finally consolidated instead of melted to form the glass.

In step (a4), the treatment may be carried out mutatis mutandis as described above in connection with the particle-to-glass process wherein the particle preforms are finally consolidated instead of melted to form the glass.

In step (b), the glass is heated to a temperature where the glass is melted, such as at a temperature higher than 1500° C., in certain embodiments above 1800° C., in certain embodiments about 2000° C. The melted glass may be further homogenized when melted in order to obtain a high homogeneity of composition and property in the final glass. Where homogenization is carried out, the glass particles melted may have essentially the same composition or differing compositions. For example, the particles may be an admixture of particles having differing [OH] and [OD]. Upon homogenization, the final glass obtained has a uniform [OH] and/or [OD].

Homogenization of consolidated glass can be carried out as well. Thus the consolidated OD-doped synthetic silica glass of the present invention or mixtures thereof, irrespective of the method of making, may be heated to an elevated temperature, such as above 1500° C., in certain embodiments above 1800° C., where they are melted and homogenized to form a glass with uniform composition and properties.

Upon homogenization, the final, cooled, consolidated glass may be further doped with molecular hydrogen as described above in connection with the particle-to-glass process wherein the particle preforms are finally consolidated instead of melted to form the glass, mutatis mutandis.

The synthetic silica glass material of the present invention can be further processed into optical members for use in the light path of lithographic irradiation of a lithographic device operating at a wavelength of below about 300 nm, such as about 248 nm, 193 nm and even shorter. The optical member may take various geometry and size. The optical member may be used in low-fluence or high-fluence irradiation paths. Thus a process for making optical member based on the silica glass of the present invention can be a combination of the processes of the present invention for making the glass material and additional steps of processing the glass material of the present invention. As mentioned supra, whereas OD-doped synthetic silica glass were studied and disclosed previously, to the best knowledge of the present inventors, none of the references discloses OD-doped synthetic silica glass capable of being used in optical members in the irradiation light path of lithographic devices operating at below about 300 nm, much less OD-doped synthetic silica glass having the unexpected optical performances at wavelengths such as about 193 nm. It is believed that the example materials disclosed in the prior art references discussed supra do not have the optical performance of the material of the present invention or the optical performance required for lithographic applications below about 300 nm.

The following non-limiting examples further illustrate the present invention.

### EXAMPLES

### Example 1

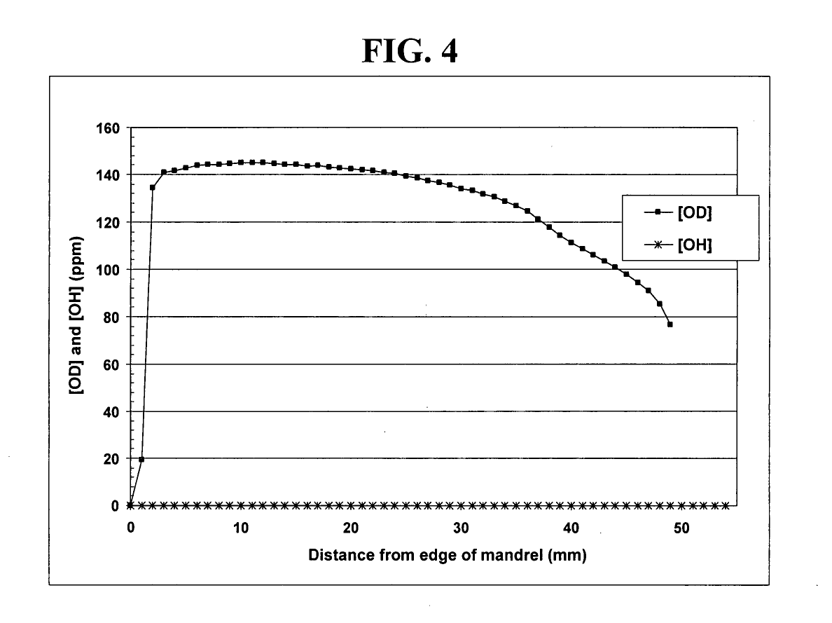

In this Example, an OD-doped fused silica glass was made by using the soot-to-glass process as described in co-pending, co-assigned patent application Ser. No. 11/148,764, entitled “HIGH REFRACTIVE INDEX HOMOGENEITY FUSED SILICA GLASS AND METHOD OF MAKING SAME” and filed on Jun. 8, 2005, the relevant part of which is incorporated herein by reference. In particular, silica soot preform was formed by depositing a plurality of soot particles obtained by flame hydrolysis of a Si-containing precursor compound on the rotating surface of a mandrel. The soot preform thus prepared was OH-doped. The soot preform was subsequently D/H exchanged and OD-doped with 99.9+% isotopic purity D₂O by bubbling helium through liquid D₂O into the consolidation furnace during the consolidation process. Deuteroxyl-doping was successful, wherein the consolidated glass comprised about 130 ppm by weight of OD and less than 1 ppm of OH. [OD] and [OH] along the radial direction of the glass was measured and presented in FIG. 4.

### Example 2

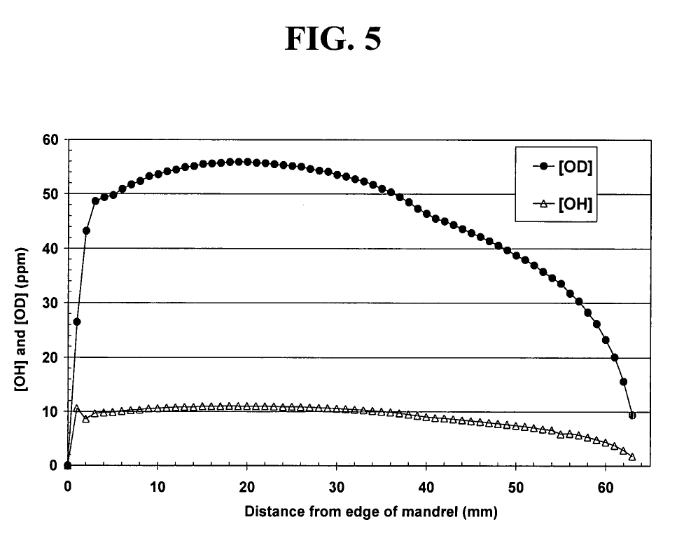

In this Example, an OD-doped fused silica glass was made by using the soot-to-glass process as described in co-pending, co-assigned patent application Ser. No. 11/148,764. In particular, silica soot preform was formed by depositing a plurality of soot particles obtained by flame hydrolysis of a Si-containing precursor compound on the rotating surface of a mandrel. The soot preform thus prepared was OH-doped. The soot preform was subsequently partially D/H exchanged and OD-doped with 99.9+% isotopic purity D₂O by bubbling helium through liquid D₂O into the consolidation furnace during the consolidation process. Deuteroxyl-doping was successful, wherein the consolidated glass comprised about 40-50 ppm by weight of OD and about 10 ppm of OH. [OD] and [OH] along the radial direction of the glass were measured and presented in FIG. 5. It is interesting to note that at different locations in the radial direction, both [OD] and [OH] vary, yet the ratio of [OD]/[OH] remains essentially constant. This indicates that the OH in the soot preform were exchanged to OD at essentially the same proportion.

### Example 3

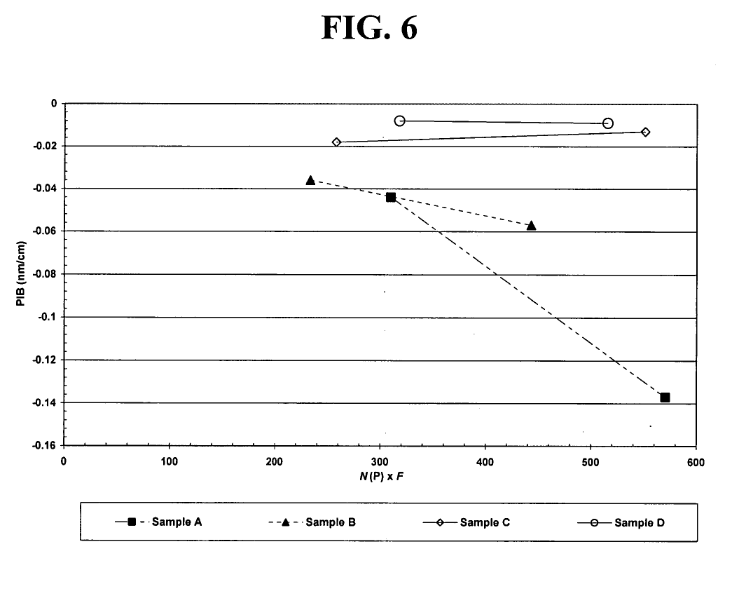

Samples of the OD-doped silica glass of Example 1 were post-loaded with H₂ or D₂ to about 4×10¹⁶ molecules/cm³ at 375° C. OH-doped glasses prepared by using the soot-to-glass process as described in co-pending, co-assigned patent application Ser. No. 11/148,764 were loaded with H₂ or D₂ to about 4×10¹⁶ or 6×10¹⁶ molecules/cm³ at 375° C. FTIR results showed that the [OH] and [OD] levels in the glasses were not changed by the H₂ or D₂ loading process. The glasses were exposed to linearly polarized 193 nm ArF excimer laser having a repetition rate of 4 kHz, a fluence of 200 μJ·cm⁻²·pulse⁻¹ and a pulse length of 25 ns for multiple millions of pulses. The exposed samples were then characterized of polarization-induced birefringence, normalized polarization-induced birefringence, normalized LIWFD measured at 193 nm, normalized LIWFD measured at 633 nm and normalized polarization-induced birefringence. Data are presented in FIGS. 6, 7, 8 and 9 respectively. Samples A, B, C, D and E have the compositions as listed in TABLE I below:

TABLE I

| | Sample | | | | |
|---|---|---|---|---|---|
| | A | B | C | D | E |
| [OH] (ppm) | 105 | 105 | — | — | 60 |
| [OD] (ppm) | — | — | 130 | 130 | — |
| [H₂] (×10¹⁷ molecules/cm³) | 0.4 | — | 0.4 | — | 0.6 |
| [D₂] (×10¹⁷ molecules/cm³) | — | 0.4 | — | 0.4 | — |

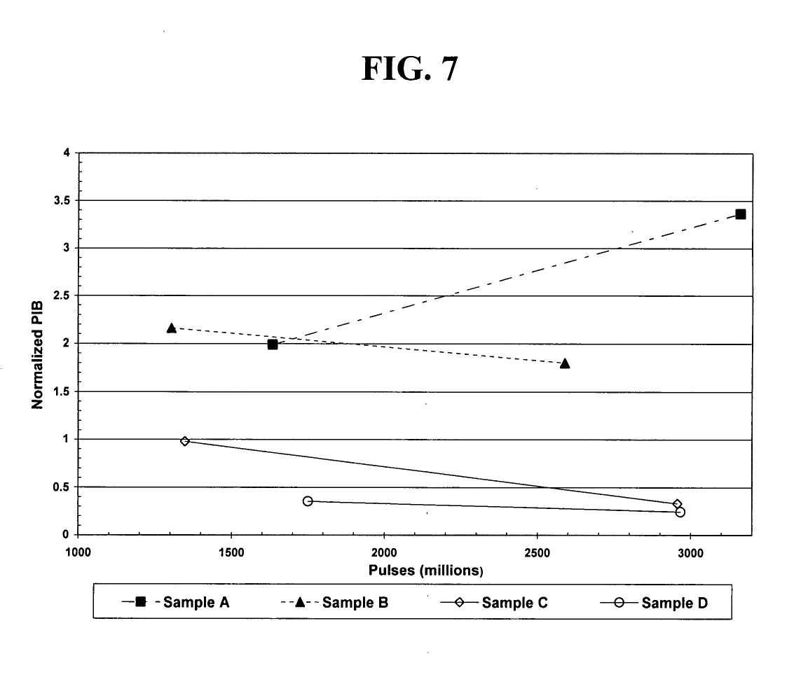

In FIG. 6, the horizontal axis represents N(P)·F, where N(P) is the number of pulses in the millions, and F is the fluence of the 193 nm excimer laser pulses in mJ/(cm²·pulse). This figure clearly shows, in a totally surprising manner, that the OD-doped samples (Samples C and D) demonstrated much less measured bulk polarization-induced birefringence (PIB(M)) at various N(P)·F. Normalized polarization-induced birefringence value provided in FIG. 7 further corroborates the conclusion that OD-doped glass samples have appreciably lower amount of polarization-induced birefringence than glasses doped by OH at comparable levels. Data in these figures clearly show that OD-doped silica glass exhibits superior performance to OH-doped silica glass in terms of polarization-induced birefringence. Even more surprisingly, PIB(M) and PIB(N) data of Sample C measured at over 8 billion pulses shows that the polarization-induced birefringence essentially did not change over those at about 2 and 5 billion pulses, in contrast to the significantly enlarged polarization-induced birefringence value of the OH-doped Samples A and B.

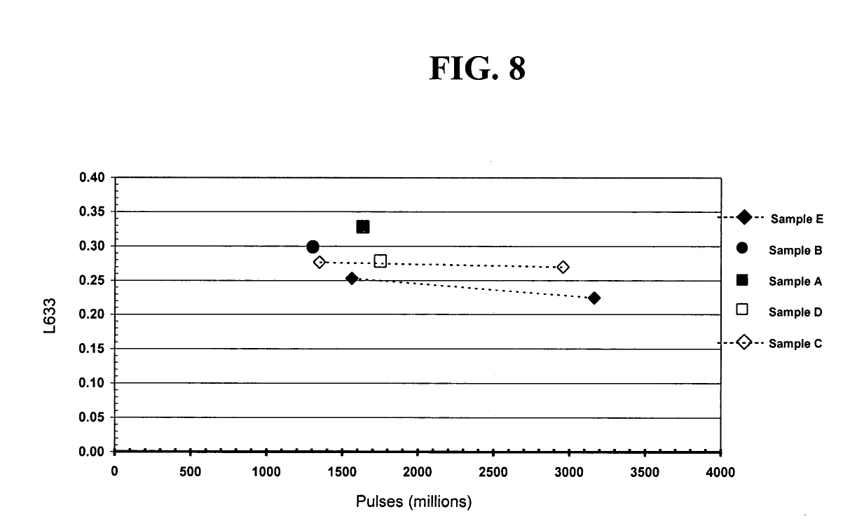

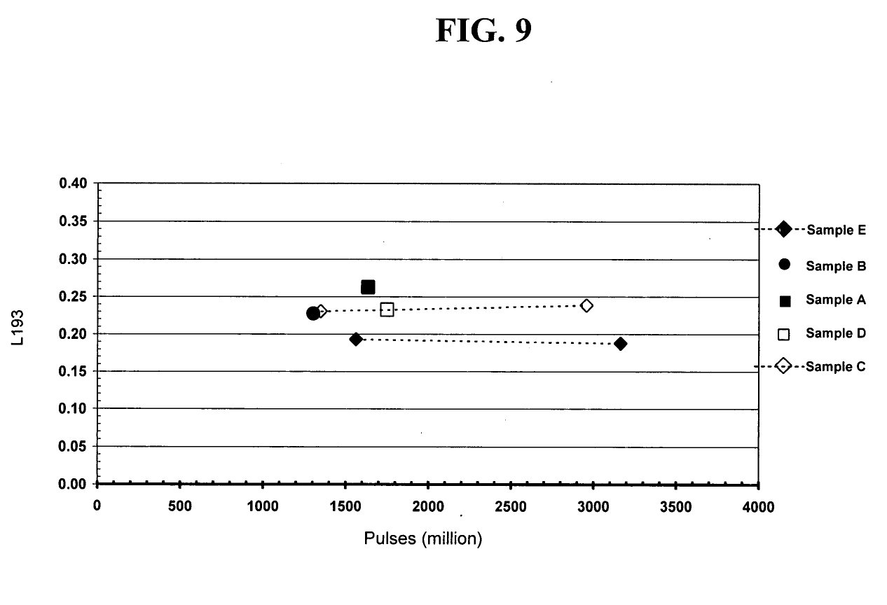

Normalized LIWFD data of Samples A, B, C, D and E in FIGS. 8 and 9 shows that the LIWFD performances of the OD-doped silica glass and OH-doped glasses are comparable when the concentrations of [OD] and [OH] are comparable.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

What is claimed is:

1. An OD-doped synthetic silica glass material capable of being used in the light path of the lithographic irradiation of a lithographic device operating at a wavelength below about 300 nm comprising OD and optionally OH, wherein the ratio of n(OD)/(n(OD)+n(OH)) is higher than 2×10⁻⁴.

2. A synthetic silica glass material according to claim 1 comprising OD and optionally OH, wherein the ratio of n(OD)/(n(OD)+n(OH)) is higher than 0.05.

3. A synthetic silica glass material according to claim 1, wherein the oxygen atoms in the OD moieties and optionally OH moieties comprise ¹⁷O and/or ¹⁸O in amounts higher than their natural isotopic abundances.

4. A synthetic silica glass material according to claim 1, wherein the ratio of n(OD)/(n(OD)+n(OH)) is higher than 0.95.

5. A synthetic silica glass material according to claim 1, which is a synthetic silica glass further doped with other dopants.

6. A synthetic silica glass material according to claim 1, which is doped with fluorine a amount between about 1-1000 ppm by weight.

7. A synthetic silica glass material according to claim 1, comprising H₂, HD, D₂ and/or mixtures thereof, wherein the sum total of [H₂], [HD] and [D₂] is between 5×10¹⁵ to 5×10¹⁹ molecules/cm³.

8. A synthetic silica glass material according to claim 1, wherein the ratio of n(D₂)/(n(D₂)+n(H₂)) or the ratio of n(H₂)/(n(D₂)+n(H₂)) is higher than 0.1, in certain embodiments preferably higher than about 0.3, in certain other embodiments preferably higher than about 0.5, in certain other embodiments preferably higher than about 0.7, in certain other embodiments preferably higher than 0.9.

9. A synthetic silica glass material according to claim 1, exhibiting a laser induced wavefront distortion (LIWFD), measured at 633 nm, of between −1.0 and 1.0 nm/cm, when subjected to 10 billion pulses of a laser beam operating at approximately 193 nm and having a fluence of approximately 70 μJ·cm⁻²·pulse⁻¹ and a pulse length of approximately 25 ns.

10. A synthetic silica glass material according to claim 1 exhibiting a normalized wavefront distortion L633 when subjected to excimer laser pulses at about 193 nm of less than or equal to about 20 billion pulses, measured at about 633 nm, wherein 0≦L633≦1.0.

11. A synthetic silica glass material according to claim 1 exhibiting a normalized wavefront distortion L193 when subjected to excimer laser pulses at about 193 nm of less than or equal to about 20 billion pulses, measured at about 193 nm, wherein 0≦L193≦1.0.

12. A synthetic silica glass material according to claim 1, wherein the OH concentration is lower than about 600 ppm by weight.

13. A synthetic silica glass material according to claim 1, wherein the glass exhibits less than about 1 nm/cm, in certain embodiments preferably less than 0.1 nm/cm, of polarization-induced birefringence measured at about 633 nm after being subjected to 5×10⁹ pulses of linearly polarized pulsed laser beam at about 193 nm having a fluence of about 40 μJ·cm⁻²·pulse⁻¹ and a pulse length of about 25 ns.

14. A synthetic silica glass material according to claim 1, wherein the glass exhibits less than about 0.1 nm/cm of polarization-induced birefringence measured at about 633 nm after being subjected to 1×10¹⁰ pulses of linearly polarized pulsed laser beam at about 193 nm having a fluence of about 40 μJ·cm⁻²·pulse⁻¹ and a pulse length of about 25 ns.

15. A synthetic silica glass material according to claim 1, wherein the glass exhibits less than about 0.1 nm/cm of polarization-induced birefringence measured at about 633 nm after being subjected to 2×10¹⁰ pulses of linearly polarized pulsed laser beam at about 193 nm having a fluence of about 40 μJ·cm⁻² ·pulse⁻¹ and a pulse length of about 25 ns.

16. A synthetic silica glass material according claim 1, wherein the glass exhibits less than about 0.04 nm/cm of polarization-induced birefringence measured at about 633 nm after being subjected to 2×10¹⁰ pulses of linearly polarized pulsed laser beam at about 193 nm having a fluence of about 40 μJ·cm⁻²·pulse⁻¹ and a pulse length of about 25 ns.

17. A synthetic silica glass material according claim 1, wherein the glass exhibits higher than about 0.001 nm/cm of polarization-induced birefringence measured at about 633 nm after being subjected to 2×10¹⁰ pulses of linearly polarized pulsed laser beam at about 193 nm having a fluence of about 40 μJ·cm⁻²·pulse⁻¹ and a pulse length of about 25 ns.

18. A synthetic silica glass material according to claim 1, wherein the glass exhibits higher than about 0.01 nm/cm of polarization-induced birefringence measured at about 633 nm after being subjected to 2×10¹⁰ pulses of linearly polarized pulsed laser beam at about 193 nm having a fluence of about 40 μJ·cm⁻²·pulse⁻¹ and a pulse length of about 25 ns.

19. A synthetic silica glass material according to claim 1, wherein the glass exhibits a polarization-induced birefringence less than about 0.04 nm/cm of polarization-induced birefringence measured at about 633 nm after being subjected to 2×10⁹ pulses of linearly polarized pulsed laser beam at about 193 nm having a fluence of about 200 μJ·cm⁻²·pulse⁻¹ and a pulse length of about 25 ns, in certain embodiments less than about 0.02 nm/cm of polarization-induced birefringence measured at about 633 nm after being subjected to 5×10⁹ pulses of linearly polarized pulsed laser beam at about 193 nm having a fluence of about 200 μJ·cm⁻²·pulse⁻¹ and a pulse length of about 25 ns.

20. A synthetic silica glass material according claim 1, wherein the glass exhibits a normalized polarization-induced birefringence less than 10, in certain embodiments less than 5, when subjected to excimer laser pulses at about 193 nm of less than or equal to about 20 billion pulses.

21. A synthetic silica glass material according to claim 1, wherein the glass exhibits a normalized polarization-induced birefringence less than 2, when subjected to excimer laser pulses at about 193 nm of less than or equal to about 2 billion pulses.

22. A synthetic silica glass material according to claim 1 having an initial internal transmission at about 193 nm of at least 99.65%/cm.

23. A synthetic silica glass material according to claim 1 having a fictive temperature of lower than about 1150° C.

24. A synthetic silica glass material according to claim 1 having a refractive index variation measured in a plane perpendicular to at least one direction of less than about 10 ppm.

25. A synthetic silica glass material according to claim 1 having a concentration variation of OH and OD ([OH]+[OD]) measured in a plane perpendicular to at least one direction of less than about 50 ppm.

26. A synthetic silica glass material according to claim 1 having a Cl concentration less than about 100 ppm.

27. A synthetic silica glass material according to claim 1, wherein the ratio of concentration of OD ([OD]) to the concentration of OH ([OH]) in different locations in the glass, i.e., [OD]/[OH], is essentially constant.

28. A synthetic silica glass material according to claim 1, wherein the ratio of the concentration of D₂ ([D₂]) to the concentration of H₂ ([H₂]) in different locations in the glass, i.e., [D₂]/[H₂], is essentially constant.

29. A synthetic silica glass material according to claim 1, comprising less than 50 ppb by weight, of any alkali metal, any alkali earth metal, and any transition metal.

30. A synthetic silica glass material according to claim 29, comprising less than 50 ppb by weight.

31. An OD-doped synthetic silica glass material according to claim 1 comprising less than about 500 ppm by weight of OH and 0.15-1400 ppm OD.

32. An OD-doped synthetic silica glass material according to claim 1 comprising less than about 150 ppm by weight of OH and about 0.1-1400 ppm OD.

33. An OD-doped synthetic silica glass material according to claim 1 comprising less than about 20 ppm by weight of OH and about 0.01-1400 ppm OD.

34. An OD-doped synthetic silica glass material according to claim 1 comprising less than about 20 ppm by weight OH and between about 0.01-300 ppm OD.

35. An OD-doped synthetic silica glass material according to claim 1 comprising less than about 20 ppm by weight OH and between about 0.01-150 ppm OD.

36. An OD-doped synthetic silica glass material according to claim 1 comprising less than about 1 ppm by weight OH and between about 0.01-150 ppm OD.

37. An optical member for use in the optical path of irradiation having a wavelength shorter than about 300 nm, consisting essentially of a synthetic silica glass material according to claim 1.

38. A lithographic system comprising at least one optical member according to claim 37.

39. A lithographic system according to claim 38, which is a lithographic system operating at a wavelength of below about 300 nm.

40. A lithographic system according to claim 39, which is an immersion lithographic system.

41. A process for making OD-doped synthetic silica glass material capable of being used in the light path of the lithographic irradiation of a lithographic device operating at a wavelength below about 300 nm, comprising the following steps:
(I) providing a plurality of particles comprising silica;
(II) depositing the plurality of particles on a supportive deposition surface at an elevated temperature such that the particles are consolidated into transparent glass material in situ,
wherein:
either in step (I), the plurality of particles provided are D-containing and/or in step (II), the deposition and consolidation are carried out in an D-containing atmosphere,
such that the obtained silica glass comprises OD and optionally OH, and the ratio of n(OD)/(n(OD)+n(OH)) is higher than about 2×10⁻⁴.

42. A process according to claim 41, wherein in step (I), the particles are generated by flame hydrolysis of at least one Si-containing precursor compound.

43. A process according to claim 42, wherein in step (I), the Si-containing precursor compound is selected from organosilicon compounds and silicon halides.

44. A process according to claim 41, wherein in step (II), the deposition is initiated on an essentially planar top surface of a horizontally rotating table.

45. A process according claim 41, wherein in step (II), the deposition and consolidation are carried out in the presence of D₂O.

46. A process according claim 41, wherein in step (II), the deposition and consolidation are carried out in the presence of H₂O.

47. A process according to claim 46, wherein the Si-containing precursor compound comprises D.

48. A process according to claim 42, wherein the flame is generated by at least one reaction involving a D-containing compound.

49. A process according to claim 41, wherein in step (I), the particles are provided via a soot gun.

50. A process according to claim 41, wherein in step (I), the particles are provided via a plasma-assisted process.

51. A process according to claim 41, further comprising the following step:
(III) treating the consolidated glass obtained in step (II) in an atmosphere comprising H₂ and/or HD and/or D2.

52. A process according to claim 51, wherein in step (III), the treatment temperature is lower than about 600° C.

53. A process according to claim 51, wherein in step (III), the treatment temperature is higher than about 600° C.

54. A process according to claim 51, wherein in step (III), the ratio of (2n(H₂)+n(HD))/2(n(H₂)+n(D₂)+n(HD)) is higher than or equal to the natural abundance of H.

55. A process according to claim 51, wherein in step (III), the ratio of (2n(D₂)+n(HD))/2(n(H₂)+n(D₂)+n(HD)) is higher than or equal to the natural abundance of D.

56. A process according to claim 51, wherein in step (III), the treatment time and temperature is chosen such that the sum total of the concentration of H₂, HD and D₂ in the treated glass is between about 0.5×10¹⁶ to about 5×10¹⁹ molecules/cm³.

57. A process according to claim 41, wherein in step (I), particles comprising dopants are provided and mixed with the particles comprising silica.

58. A process according to claim 57, wherein the particles comprising dopants comprise at least one of Cl, TiO₂, F and Al₂O₃.

59. A process for making OD-doped synthetic silica glass material capable of being used in the light path of the lithographic irradiation of a lithographic device operating at a wavelength below about 300 nm, comprising the following steps:
(A) providing a particle preform comprising a plurality of particles comprising silica;
(B) optionally purifying and/or drying the particle preform;
(C) optionally further doping the particle preform with dopants;
(D) consolidating the particle preform at an elevated temperature to dense glass; and
(E) optionally treating the consolidated glass obtained in step (D) in the presence of H₂, HD and/or D₂,
wherein in at least one of steps (A), (B), (C), (D) and (E), OD is introduced or formed into the glass.

60. A process according to claim 59, wherein in at least one of steps (A), (B), (C) and (D), OD is introduced or formed into the glass.

61. A process according to claim 59, wherein step (A) comprises the following steps:
(A1) providing a plurality of particles; and
(A2) depositing the particles on a rotating supporting surface to form the particle preform.

62. A process according to claim 61, wherein in step (A1), the particles are provided by (A1.1) flame hydrolysis of at least one silicon-containing precursor compound, which may be plasma-assisted; or (A1.2) a soot gun, which may be plasma assisted; or (A1.3) other plasma-assisted process.

63. A process according to claim 62, wherein in step (A1), the particles are provided by (A1.1), and the particles are essentially not OD-doped.

64. A process according to claim 62, wherein in step (A1), the particles are provided by (A1.1), and the particles provided are OD-doped.

65. A process according to claim 64, wherein in step (A1), the particles are provided by flame hydrolysis in the presence of a D-containing compound.

66. A process according to claim 65, wherein in step (A1), the particles are provided by flame hydrolysis in the presence of D₂O.

67. A process according claim 61, wherein in step (A2), the deposition involves a process selected from (A2.1) outside vapor deposition; (A2.2) inside vapor deposition; (A2.3) vapor axial deposition; and (A2.4) planar deposition.

68. A process according to claim 59, wherein step (A) comprises the following steps:
(A(i)) forming a sol-gel comprising silica; and
(A(ii)) forming the particle preform from the sol-gel.

69. A process according to claim 68, wherein step (A(i)) is carried out in the presence of or from a D-containing compound.

70. A process according to claim 69, wherein step (A(i)) is carried out in the presence of D₂O.

71. A process according to claim 59, wherein step (B) is carried out and such step is carried out in an atmosphere comprising at least one purifying/drying agent selected from F₂, Cl₂, Br₂, a halogen-containing compound, CO, CO₂, and compatible mixtures thereof.

72. A process according to claim 71, wherein the halogen-containing compound is selected from HX, COX₂, SOX₂, CX₄ and SX₆, wherein X is selected from F, Cl, Br and combinations thereof.

73. A process according to claim 71, wherein step (B) is carried out in an atmosphere comprising Cl₂, Br₂ or mixtures thereof.

74. A process according to claim 71, wherein immediately after step (B), the particle preform has an [OH]+[OD] less than about 50 ppm by weight of the total composition.

75. A process according to claim 59, wherein step (C) is carried out, and such step is carried out in the presence of an atmosphere comprising dopant(s).

76. A process according to claim 75, wherein step (C) is carried out in the presence of a D-containing compound.

77. A process according to claim 75, wherein step (C) is carried out in the presence of D₂O, D₂ or both.

78. A process according to claim 76, wherein in step (C) exchange of OD for OH is carried out.

79. A process according to claim 78, wherein immediately after step (C), the ratio of n(OD)/(n(OD)+n(OH)) in the particle preform is higher than about 0.02.

80. A process according to claim 59, if step (B) or step (C) is carried out, at least one of these two steps is carried out in the presence of a reductive atmosphere.

81. A process according to claim 80, wherein in the reductive atmosphere in which step (B) or step (C) is carried out comprises a gas selected from H₂, D₂, HD, hydrocarbons, D-containing hydrocarbons, and the like.

82. A process according to claim 80, wherein after step (B) or step (C), if carried out, and whichever is later, an oxidation step (C(A)) is carried out wherein the particle preform is subjected to an oxidative atmosphere in which oxygen-deficient sites in the particle preform can be healed.

83. A process according to claim 82, wherein step (C(A)) is at least part of step (D).

84. A process according to claim 82, wherein the oxidative atmosphere in step (C(A)) comprises H₂O, D₂O, O₂ and/or O₃.

85. A process according to claim 59, wherein steps (B) and (C) are carried out at least partially simultaneously.

86. A process according to claim 59, wherein steps (C) and (D) are carried out at least partially simultaneously.

87. A process according to claim 59, wherein step (D) is carried out in an atmosphere comprising He.

88. A process according to claim 59, wherein step (D) is carried out in an atmosphere comprising O₂.

89. A process according to claim 59, wherein step (D) is carried out in the presence of H₂O.

90. A process according to claim 59, wherein step (D) is carried out in the presence of D₂O.

91. A process according to claim 90, wherein step (D) is carried out in an atmosphere essentially free of H₂O and HDO.

92. A process according to claim 59, wherein step (D) is carried out in the presence of D₂, HD or both.

93. A process according to claim 59, wherein step (E) is carried out, and such step (E) is carried out in the presence of H₂.

94. A process according to claim 93, wherein step (E) is carried out in an atmosphere essentially devoid of D₂ and HD.

95. A process according to claim 94, wherein step (E) is carried out at a temperature lower than about 600° C.

96. A process according to claim 92, wherein step (E) is carried out at a tem97.

97. A process according to claim 59, wherein step (E) is carried out, and such step (E) is carried out in the presence of D₂ and/or HD.

98. A process according to clam 97, wherein step (E) is carried out in an atmosphere essentially devoid of H₂.

99. A process according to claim 98, wherein step (E) is carried out in an atmosphere essentially devoid of HD and H₂.

100. A process according to claim 97, wherein step (E) is carried out at a temperature higher than about 600° C.

101. A process for making OD-doped synthetic silica glass capable of being used in the light path of the lithographic irradiation of a lithographic device operating at a wavelength below about 300 nm, comprising the following steps:
(a) providing a plurality of OD-doped particles comprising silica; and
(b) melting the particles at an elevated temperature to obtain a transparent glass.

102. A process according to claim 101, wherein step (a) comprise the following steps:
(a1) generating a plurality of particles comprising silica;
(a2) optionally purifying and/or drying the particles; (a3) optionally doping the particles in an atmosphere comprising at least one D-containing compound, and
(a4) optionally treating the particles in an oxidative atmosphere to at least partly heal oxygen-deficient sites in the particles.

103. A process according to claim 102, wherein in step (a3), the at least one D-containing compound comprises D₂O.

104. A process according to claim 101, wherein step (a) involves flame hydrolysis of a Si-containing precursor compound.

105. A process according to claim 101, wherein step (a) involves a sol-gel process of a Si-containing compound.

106. A process according to claim 101, wherein in step (b), the melted glass is also homogenized.

107. A process according to claim 101, further comprising the following step (c) after step (b):
(c) treating the glass in an atmosphere comprising H₂, D₂ and/or HD.

108. A particle preform formed during a process of claim 59 before consolidation thereof.

109. A particle preform according to claim 108, which is formed by any of the following methods: (I) outside vapor deposition; (II) inside vapor deposition; (III) vapor axial deposition (VAD); and (IV) planar deposition.

110. A process for making OD-doped synthetic silica glass capable of being used in the light path of the lithographic irradiation of a lithographic device operating at a wavelength below about 300 nm, comprising the following steps:
(a) providing at least one consolidated OD-doped silica glass;
(b) melting the OD-doped silica glass and homogenizing it at an elevated temperature to obtain a glass having an essentially uniformly distributed [OD] and/or [OH] therein.

111. A process according to claim 110, wherein:
in step (a), at least two OD-doped silica glasses having differing [OD] are provided; and
in step (b), the at least two silica glasses are mixed and homogenized.
